(19) United States
(12) Patent Application Publication
(10) Pub. No.: US 2005/0157745 A1
(43) Pub. Date: Jul. 21, 2005

(54) Communication management method, control station, communication station, communication management program, and recording medium containing the communication management program

(76) Inventors: Hidekazu Fujii, Soraku-gun (JP); Yoshihiro Ohtani, Soraku-gun (JP); Hitoshi Azuma, Tenri-shi (JP); Akira Nishikawa, Tenri-shi (JP)

Correspondence Address: BIRCH STEWART KOLASCH & BIRCH, PO BOX 747, FALLS CHURCH, VA, 22040-0747, US

(21) Appl. No.: 10/505,128

(22) PCT Filed: Feb. 27, 2003
(86) PCT No.: PCT/JP03/02276

(30) Foreign Application Priority Data
May 8, 2002 (JP) 2002-133303
Jul. 5, 2002 (JP) 2002-198003

(51) Int. Cl. H04L 12/403

(52) U.S. Cl. 370/449

(57) ABSTRACT

The subject invention provides a communication management system that allots transmission rights according to requests from the communication stations. The allocation of the transmission rights is carried out within a specified predefined period. The system re-allots transmission rights to at least a part of the communication stations at a time point where all communication stations, that have been provided with transmission rights, consume their transmission right grant periods, or complete their transmission within the transmission right grant periods. With this arrangement, it is possible to securely prevent waste of the communication band, realizing effective use of the communication band. Further, the transmission station in a tolerable communication condition can be immune to bad influence from the transmission station in a bad condition.

### TECHNICAL FIELD

The present invention relates to a communication management method for enabling effective use of the communication band, preventing bad influence on a transmission station in a good communication condition, when the communication is performed between a control station and a plurality of communication stations. The present invention also relates to a control station, communication stations and a communication management program for realizing the communication management method.

### BACKGROUND ART

FIG. 38 shows a communication system according to IEEE Std 802.11e/D3.0, May 2002 formulated by 802.11 Tge (Task Group E), in which the control station transmits CF-Poll to a transmission station as provision of a transmission right, thus allowing the transmission station to transmit data (packet) to a reception station during the given period (TXOP).

Before actual transmission of data, the transmission station notifies the control station of summary of the data that the transmission station wishes to transmit to the reception station, using TSpec (the detail is described later). In response to this, the control station determines whether or not the scheduling is possible (the data is acceptable) according to the notification.

The transmission station (STA) reports communication condition, such as the current buffering condition, to the scheduler of the control station via QoS Null, as required. The information reported through QoS Null contains the buffering condition and required length for transmission right.

In the meantime, the scheduler of the control station determines carries out adjustment of the time to be given in the next period, according to the TSpec and the report via QoS Null, and updates the schedule.

Note that, when all data in the transmission station are transmitted before consuming the given period (TXOP), the transmission station finishes the period (TXOP) earlier.

Aside from this, the physical rate deliberated in 802.11a defines plural types of transmission PHY rates: 54 Mbps, 48 Mbps, 36 Mbps, 24 Mbps, 12 Mbps, 9 Mbps and 6 Mbps. A change in transmission PHY rate greatly changes the transmittable distance and time taken for transmission. As shown in FIG. 39, the transmittable distance of 6 Mbps is several times larger than that of 54 Mbps.

In general data transmission, an increase of transmission distance raises the error rate of transmission, thereby requiring a small physical rate (transmission PHY rate). In this case, greater (longer) TXOP is required for the data transmission to ensure the same application rate. However, this causes some difficulties to support a large number of transmission stations, thereby blocking connections of some transmission stations into the network.

Meanwhile, support for a large number of transmission stations (streams) causes a decrease (reduction) of the TXOP for each transmission station (stream). However, this causes some difficulties to extend the transmission distance.

Incidentally, in the case of, for example, 802.11, the transmission PHY rate automatically changes at the application layer level of the transmission station (Sender).

Conventional major demand was completion of data communication no matter how much time is required, as the data communication is mainly for exchange of document data or browse of WEB pages. For this reason, fluctuation of effective throughput due to the communication condition by the user did not cause a major problem.

However, in data communication requiring real-time transmission, such as a video image etc., it is indispensable that data transmission requested by the transmission application is securely completed within a certain period.

However, the communication time occupied by a single communication station greatly differs depending on the communication distance, and therefore, when a plurality of communication stations are present, it is more convenient if the user is capable of setting the number of transmission stations for simultaneous communication, the communication distances of the respective stations etc., according to the requirement.

Note that, the TSpec mentioned above contains such as Traffic Type, FEC (Forward Error Collection), Ack Policy, Nominal MSDU size, and Mean data Rate. The Traffic Type denotes whether the data is a periodic data or a non-periodic data. FEC denotes the presence/absence of FEC. Ack Policy denotes the Ack Policy selected from 802.11 Normal Ack that immediately demands confirmation of delivery of packet to the reception station, no-Ack not requiring the confirmation of delivery of packet, or Burst-Ack that demands confirmation of delivery of packet to the reception station after a while. Nominal MSDU size denotes the length of MSDU (data). Mean Data Rate denotes an average data rate.

However, such a conventional art has the following problems.

According to IEEE Std 802.11e/D3.0, May 2002 formulated by 802.11 Tge (Task Group E), the control station does not perceive the physical rate or types of data to be transmitted used in the transmission station, and therefore cannot predict the optimum length for the concerned transmission station. Thus, there is no specific method for scheduling.

Further, as shown in FIG. 38, in the case of a system containing a control station and a plurality of transmission stations, if the scheduling is performed by directly reflecting the communication condition reported through QoS Null, a transmission station in a bad condition (a transmission station requiring a long TXOP) affects other transmission stations in a good condition.

Further, as mentioned above, increasing the transmission distance and supporting a large number of transmission stations conflict with each other. In this view, when providing the TXOPs to the transmission stations, the described prior art has no guideline to decide whether priority should be given to the distance of TXOP or should be given to the support for a plurality of transmission stations. Further, when the control station is operated with priority on the distance and therefore provides a great length of TXOP to the first transmission station to support its transmission stream, there is no way to inform the user of the resulting shortage of TXOP and the fact that the control station cannot support the second or third transmission stream, i.e., the control station cannot enable the second or third transmission station to be connected to the network.

Further, as described, to carry out the data communication requiring real-time transmission such as a video image, it is necessary to ensure the required minimum PHY rate to achieve the throughput assumed by the transmission station application.

Incidentally, the newly established parameter Minimum Tx Rate allows modification into a value equal to or greater than the minimum PHY rate depending on the communication condition; however, no guideline is given as to what value is preferred for the modified rate. This may raise the following defect.

For example, here assumes a case where three users are whishing to see three images at the same time even within a narrow range; for example, the three family members each have a mobile TV receiver, and each wish to use the TV anytime they want (however, each of them only requires to use the TVs in his/her own room). In this case, if one of them goes away from the other two with the TV (it is ON, and the other two TVs are OFF), the application layer automatically (at its own judgment) decreases the transmission PHY rate from 36 Mbps to 12 Mbps. Accordingly, the other two family members cannot use their TVs when they turn them on after the decrease.

In such a case, they do not know why their TV receiver do not work (the reason is, the transmission PHY rate 36 Mbps allows reception for three TV receivers; but the rate 12 Mbps requires time approximately three times longer than the 36 Mbps, thus failing to reception for the other two receivers.).

Further, when a user wishes to watch a stream of image with a wide communication range, the user try to ensure the enough range by decreasing the transmission PHY rate. However, when the application layer automatically (at its own judgment) increases the transmission PHY rate, the communication range is narrowed.

As has been described, in the prior art above, the application layer automatically switches the transmission PHY rate, and the users cannot obtain the assumed minimum transmission rate, thereby failing to carry out communication according to the user's requirement.

The present invention is made in view of the foregoing conventional problems, and an object thereof is to provide an optimum communication management method.

### DISCLOSURE OF INVENTION

In order to solve the foregoing problems, a communication management method according to the present invention is used for a communication system that is made up of a plurality of communication stations and a control station for controlling transmission rights of said communication stations, said method being performed by the control station and comprising the step of: allotting a transmission right grant period to at least one of said communication stations within a predefined period according to a request for transmission right from said at least one of the communication stations, said predefined period being specified in length.

When a plurality of communication stations exist, only a transmission station currently having a transmission right is allowed to carry out data transmission, and the control station provides the transmission station with the length adjusted according to the information supplied from the transmission station. In this case, if the provision of transmission right to the transmission stations performed by the control station is not limited to a specific period, as with a generally-adopted method, the control station will have to handle limitless amount of data to manage the order of provision and the length of the transmission right for the number of transmission stations.

In this view, the communication management system is arranged so that the control station controls provision of a transmission right to each of the respective transmission stations with a periodic interval. In this manner, the control station is allowed to control time information of the transmission right to be given at periodic intervals, and therefore the control station will have to manage the order of provision and the length of the transmission right for the number of transmission stations within the periodic interval, thereby securely reducing the information amount to be managed.

Further, in addition to the foregoing arrangement, the communication management method of the present invention may be arranged so that said predefined period is continuously set while having a certain periodicity.

With this arrangement, since the predefined period is continuously set while having a certain periodicity, the control station needs to handle certainly less quantity of information for the plural communication stations, such as the order of provision or the length of the transmission right etc., than the case where the predefined period is discontinuously set.

Further, a communication management method according to the present invention is used for a communication system that is made up of a plurality of communication stations and a control station for controlling transmission rights of said communication stations, said method being performed by the control station and comprising the steps of: (a) allotting a transmission right grant period to at least one of said communication stations within a predefined period according to a request for transmission right from said at least one of the communication stations; and (b) re-allotting a transmission right to at least one of said communication stations within said predefined period at a time point where all communication stations, that have been provided with transmission rights, consume their transmission right grant periods, or complete their transmission within said transmission right grant periods.

As the control station carries out the allocation of the transmission right to the communication stations within the predefined period, a blank period may be produced when a part (or the whole) of the communication stations consumes the transmission period allotted thereto or completes data transmission before consuming the transmission right grant time. In this case, the foregoing method re-allots the transmission right to at least one of the communication stations. In this manner, it is possible to securely prevent waste of the communication band, thereby realizing effective use of the communication band.

Further, in addition to the foregoing arrangement, the communication management method of the present invention may be arranged so that: the re-allocation is performed in accordance with one of: (i) buffer conditions or requested lengths of the transmission rights, reported from said communication stations, (ii) actual lengths that have been allotted to said communication stations, (iii) a priority previously decided for each communication station, or (iv) a combination of at least two of (i) through (iii).

In this case, it is possible to securely prevent waste of the communication band, thereby securely realizing effective use of the communication band. Further, the transmission right is re-allotted to the communication station in a bad communication condition and/or precedent in priority, thereby realizing immediate error correction for the transmission station to which the transmission right is given.

Further, a communication management method according to the present invention is used for a communication system that is made up of a plurality of communication stations and a control station for controlling transmission rights of said communication stations, said method being performed by the control station and comprising the step of: (a) allotting a transmission right grant period to at least one of said communication stations within a predefined period according to a request for transmission right from said at least one of the communication stations, said transmission right grant period allotted within said predefined period being decided according to previous communication conditions and/or characteristics of said communication stations.

As the control station carries out the allocation of the transmission right to the communication stations within the predefined period, a blank period may be produced when a part (or the whole) of the communication stations consumes the transmission period allotted thereto or completes data transmission before consuming the transmission right grant time. In this case, the foregoing method re-adjusts the reallocation of transmission right of at least a part of the communication stations. In this manner, it is possible to securely prevent waste of the communication band, thereby realizing effective use of the communication band. Further, such a readjustment enables provision of transmission right according to the respective communication conditions of the communication stations.

Further, in addition to the foregoing arrangement, the communication management method of the present invention may be arranged so that: the reallocation of the transmission right is carried out in accordance with one of: (i) buffer conditions or requested lengths of the transmission rights, reported from said communication stations, (ii) actual length that have been allotted to said communication stations, (iii) a priority previously decided for each communication station, or (iv) a combination of at least two of (i) through (iii).

In this case, it is possible to securely prevent waste of the communication band, thereby securely realizing effective use of the communication band. Further, the transmission right is re-allotted to the transmission station in a bad communication condition and/or precedent in priority, thereby realizing immediate error correction for the transmission station to which the transmission right is given.

Further, a communication management method according to the present invention is used for a communication system that is made up of a plurality of communication stations and a control station for controlling transmission rights of said communication stations, said method being performed by the control station and comprising the step of: allotting a transmission right grant period to at least one of said communication stations within a predefined period according to a request for transmission right from said at least one of the communication stations, said transmission right grant period having an upper limit and/or a lower limit.

The control station carries out the allocation of the transmission right according to the request from the communication station. Here, if a plurality of transmission stations are present, and the allocation of the transmission right is performed by directly reflecting the request for the transmission right from the communication stations, a transmission station in a bad condition may cause some influence on a transmission stations in a tolerable condition.

In this view, the foregoing method sets an upper limit and/or a lower limit of the transmission right grant time given to the communication station. With this arrangement, setting the upper limit prevents the transmission station in a tolerable communication condition from bad influence of the transmission station in a bad condition. Further, setting of the lower limit guarantees the minimum length for the transmission right grant period, thus allowing the system to carry out stable data transmission. This contributes significant improvement in reliability.

Further, in addition to the foregoing arrangement, the communication management method of the present invention may be arranged so that: a reference value of the transmission right grant period is set for each of said communication stations, and when decided transmission right grant periods to be allotted falls outside the predefined period, a transmission right grant period for a communication station requiring a transmission right grant period with a larger difference than a corresponding reference value is preferentially reduced, so that said transmission rights can be provided within the predefined period.

When the system includes a transmission station in a bad communication condition, the resulting adjustment value of the given time for the respective transmission station may fall outside the period. In this case, if the transmission right is continuously provided to the transmission station in a bad communication station, it causes some bad influence on other transmission stations in a normal communication condition.

In this view, the foregoing communication management system carries out calculation to find the difference between the resulting adjustment value of given time for each transmission station and a corresponding predetermined reference value, and then preferentially reduces the time given to the transmission station requested a value with a larger difference from the reference value. This arrangement disables the transmission station having the great difference to carry out desirable transmission, however prevents some bad influence exerted on the other transmission stations, thus allowing them to carry on the transmission.

Further, a communication management method according to the present invention is used for a communication system that is made up of a plurality of communication stations and a control station for controlling transmission rights of said communication stations, said method being performed by the control station and comprising the step of: allotting a transmission right grant period to at least one of said communication stations within a predefined period according to a request for transmission right from said at least one of the communication stations, an operation mode being switched between a distance priority mode and a station number priority mode.

Generally, increasing the transmission distance and supporting a large number of transmission stations (stream) conflict with each other. In this view, upon provision of the transmission rights to the transmission stations, the conventional method has no guideline to refer to the user's intention to decide whether the priority should be given to the distance or should be given to the support for a plurality of transmission stations (stream).

In view of this problem, the foregoing communication management method is arranged to enable selection between a distance priority mode and a station number priority mode. On this account, the user can carry out desirable mode setting.

Further, in addition to the foregoing arrangement, the communication management method of the present invention may further comprise the step of: setting a threshold value to be used for judgment as to whether a minimum transmission rate, that is a minimum value of a transmission rate notified by a transmission station, is acceptable or not.

As the application layer of the transmission station automatically switches the transmission rate, it may cause a defect that the users cannot obtain the assumed minimum PHY rate. In this view, the foregoing communication management system allows setting of a threshold value to be used for judgment as to whether a minimum transmission rate, that is a minimum value of a transmission rate notified by a transmission station, is acceptable or not.

On this account, even when the transmission rate is automatically changed at the transmission station application layer level, the user is allowed to change the threshold value to an appropriate value for the desired usage, thereby securely preventing the defect.

Further, in addition to the foregoing arrangement, the communication management method of the present invention may be arranged so that: said threshold value is differently decided for the distance priority mode and for the station number priority mode.

For example, here assumes a case where a plurality of users are whishing to see a plurality of images at the same time with their TV receivers even within a narrow range. In this case, if the application layer automatically (at its own judgment) decreases the transmission PHY rate when one of the TV receivers is ON and the other two TVs are OFF, the TV receivers that turn on after the decrease do not work. Further, if a user wishes to watch a stream of image with a wide communication range, the user try to ensure the range enough for it. However, when the application layer automatically (at its own judgment) increases the transmission PHY rate, the communication range may be narrowed.

In this case, as with the foregoing arrangement, if the control station sets the threshold value differently for the distance priority mode and the station number priority mode, the threshold value may be changed according to the user's desired usage. Accordingly, the user is allowed to watch a plurality of images at the same time with a plurality of TV receivers (station number priority mode), and also to watch a stream of image with a wide communication range without decreasing picture quality (distance priority mode).

Further, in addition to the foregoing arrangement, the communication management method of the present invention may further comprise the step of: receiving a request for mode change from a transmission station or a reception station.

Further, in addition to the foregoing arrangement, the communication management method of the present invention may further comprise the step of: when the operation mode is changed, notifying a transmission station or a reception station of the mode change. On this account, the change of the operation mode of the control station can be seen in the transmission station or the reception station.

Further, in addition to the foregoing arrangement, the communication management method of the present invention may further comprise the step of: when the operation mode is not changed, displaying in display means provided in said control station a notification that the operation mode is not changed. On this account, the user may be notified at the control station that the operation mode of the control station is not changed.

Further, in addition to the foregoing arrangement, the communication management method of the present invention may further comprise the step of: when the operation mode is not changed, displaying in display means provided in said control station a reason why the operation mode is not changed. On this account, the user may be notified of the reason why the operation mode is not changed, thus taking a necessary action.

Further, in addition to the foregoing arrangement, the communication management method of the present invention may further comprise the step of: when the operation mode is not changed, notifying a transmission station and/or a reception station that the operation mode is not changed.

On this account, the transmission station and the reception station that had requested the change of the operation mode may be notified that the request for change is rejected.

Further, in addition to the foregoing arrangement, the communication management method of the present invention may further comprise the step of: when the operation mode is not changed, notifying a transmission station and/or a reception station of a reason why the operation mode is not changed.

On this account, the transmission station and the reception station that had requested the change of the operation mode may be notified that the request for change is rejected, thus allowing the user to take a necessary action.

Further, in addition to the foregoing arrangement, the communication management method of the present invention may further comprise the step of: displaying in display means provided in said control station a current operation mode and an operation mode requested by said transmission or said reception station.

With this arrangement, the operation mode of the control station may be recognized on sight.

Further, a control station according to the present invention is provided in a communication system that is made up of a plurality of communication stations and a control station for controlling transmission rights of said communication stations, said control station comprising: a reception section for receiving requests for transmission right from said plurality of communication stations; a transmission section for transmitting information to provide transmission rights with respect to at least a part of said communication stations; and a scheduling section for carrying out said communication management method as set forth in any one of claims 1 through 8.

With this arrangement, a control station for realizing the present invention may be provided.

Further, a communication management method according to the present invention is used for a communication system that is made up of a plurality of communication stations and the foregoing control station of the present invention for controlling transmission rights of said communication stations, said method being performed by the communication station and comprising the step of: displaying in display means provided in said communication station whether said control station is operated under the distance priority mode or the station number priority mode.

With this arrangement, the display as to whether the control station is operated under the distance priority mode or the station number priority mode is carried out in the communication station. With this display, the user can be aware of the mode (the distance priority mode or in the station number priority mode) in which the system is operated, and therefore is allowed to quickly take an appropriate action.

Further, a communication management method according to the present invention is used for a communication system that is made up of a plurality of communication stations and the foregoing control station of the present invention for controlling transmission rights of said communication stations, said method being performed by the communication station and comprising the step of: when there is a transmission station that cannot be connected to a communication network of the communication system, displaying in display means provided in said communication station a reason why the transmission station cannot be connected to the communication network.

With this arrangement, for example, if the second and later transmission stations (streams) are not provided with the transmission right, the monitor of the communication station displays the message like “the transmission stations (streams) cannot be supported due to a line problem”. With this display, the user can decide whether the current mode is appropriate or not, and therefore is allowed to take an appropriate action, for example, change the current control mode to more appropriate mode.

Further, a communication management method according to the present invention is used for a communication system that is made up of a plurality of communication stations and the foregoing control station of the present invention for controlling transmission rights of said communication stations, said method being performed by the communication station and comprising the step of: when said communication station carries out transmission, requesting to said control station change of the operation mode to the distance priority mode or to the station number priority mode.

With this arrangement, the operation mode of the control station may be changed also at the transmission station.

Further, in addition to the foregoing arrangement, the communication management method of the present invention may further comprise the step of: when said communication station carries out transmission, displaying in display means provided in said control station a current operation mode of said control station, and an operation mode that has been requested to said control station.

With this arrangement, the user can confirm the operation mode currently requested to the control station at the transmission station.

Further, in addition to the foregoing arrangement, the communication management method of the present invention may further comprise the step of: upon reception of a notification from said control station informing that the operation mode is changed, displaying the notification in display means provided in said communication station.

With this arrangement, the change of the operation mode of the control station can be seen in the transmission station.

Further, in addition to the foregoing arrangement, the communication management method of the present invention may further comprise the step of: upon reception of a notification from said control station informing that a request for mode change is rejected, displaying the notification in display means provided in a communication station that had transmitted the request.

With this arrangement, the transmission station having been transmitted the request for change may be informed that the request has been rejected.

Further, in addition to the foregoing arrangement, the communication management method of the present invention may further comprise the step of: upon reception of a notification from said control station informing that a request for mode change is rejected, displaying a reason why the request is rejected in display means provided in a communication station that had transmitted the request.

On this account, the user can take a necessary action.

Further, a communication management method according to the present invention is used for a communication system that is made up of a plurality of communication stations and the foregoing control station of the present invention for controlling transmission rights of said communication stations, said method being performed by the communication station and comprising the step of: upon reception of data from a transmission station, requesting to said control station via said transmission station change of the operation mode to the distance priority mode or to the station number priority mode.

With this arrangement, the operation mode of the control station may be changed at any one of the control station, the transmission station, and the reception station.

Further, in addition to the foregoing arrangement, the communication management method of the present invention may further comprise the step of: when said communication station carries out reception, displaying in display means provided in said control station a current operation mode of said control station, and an operation mode that has been requested to said control station.

With this arrangement, the operation mode of the control station may be recognized on sight.

Further, in addition to the foregoing arrangement, the communication management method of the present invention may further comprise the step of: upon reception of a notification from said control station via said transmission station informing that the operation mode is changed, displaying the notification in display means provided in said communication station.

With this arrangement, the change of the operation mode of the control station can be seen in the reception station.

Further, in addition to the foregoing arrangement, the communication management method of the present invention may further comprise the step of: upon reception of a notification from said control station informing that a request for mode change is rejected, displaying the notification in display means provided in a communication station that had transmitted the request.

With this arrangement, the reception station having been transmitted the request for change may be informed that the request has been rejected.

Further, in addition to the foregoing arrangement, the communication management method of the present invention may further comprise the step of: upon reception of a notification from said control station informing that a request for mode change is rejected, displaying a reason why the request is rejected in display means provided in a communication station that had transmitted the request.

On this account, the user can take a necessary action.

Further, a communication management method according to the present invention is used for a communication system that is made up of a plurality of communication stations and the foregoing control station of the present invention for controlling transmission rights of said communication stations, said method being performed by the communication station and being arranged so that: an operation mode for transmission can be switched between a high-speed transmission mode and a low-speed transmission mode.

Further, in addition to the foregoing arrangement, the communication management method of the present invention may be arranged so that: a minimum transmission rate, that is a minimum value of a transmission rate, is set.

As the application layer of the transmission station automatically switches the transmission rate, it may cause a defect that the users cannot obtain the assumed minimum PHY rate. In this view, it is preferable that the foregoing communication management system allows setting of a threshold value, that is a minimum value of a transmission rate.

On this account, even when the transmission rate is automatically changed at the transmission station application layer level, the user is allowed to change the threshold value to an appropriate value for the desired usage, thereby securely preventing the defect.

Further, in addition to the foregoing arrangement, the communication management method of the present invention may be arranged so that: said minimum transmission rate is differently decided for the high-speed transmission mode and for the low-speed transmission mode.

For example, here assumes a case where a plurality of users are whishing to see a plurality of images at the same time with their TV receivers even within a narrow range. In this case, if the application layer automatically (at its own judgment) decreases the transmission PHY rate when one of the TV receivers is ON and the other two TVs are OFF, the TV receivers that turn on after the decrease do not work. Further, if a user wishes to watch a stream of image with a wide communication range, the user try to ensure the range enough for it. However, when the application layer automatically (at its own judgment) increases the transmission PHY rate, the communication range may be narrowed.

In this case, as with the foregoing method, if the transmission rate is differently decided for the high-speed transmission mode and for the low-speed transmission mode, the threshold value may be changed according to the user's desired usage. Accordingly, the user is allowed to watch a plurality of images at the same time with a plurality of TV receivers, and also to watch a stream of image with a wide communication range without decreasing picture quality.

Further, in addition to the foregoing arrangement, the communication management method of the present invention may comprise the step of: when the operation mode is changed, notifying said reception station on a receiving end and said control station of the mode change.

With this arrangement, the change of the operation mode of the communication station can be seen in the control station or in the reception station.

Further, in addition to the foregoing arrangement, the communication management method of the present invention may further comprise the step of: displaying in display means provided in said communication station a current operation mode.

With this arrangement, the operation mode of the transmission station may be recognized on sight.

Further, in addition to the foregoing arrangement, the communication management method of the present invention may comprise the step of: upon reception of a notification from said control station informing that the operation mode is changed, displaying the notification in display means provided in said communication station.

With this arrangement, the change of the operation mode of the control station can be seen in the communication station.

A communication management method according to the present invention is performed by a communication station operating as a reception station for carrying out reception from a communication station operating as a transmission station for carrying out the foregoing communication management method of the present invention, said method comprising the step of: displaying in display means provided in said communication station as a reception station a current operation mode of said transmission station.

With this arrangement, the operation mode of the transmission station may be recognized on sight in the reception station.

Further, in addition to the foregoing arrangement, the communication management method of the present invention may further comprise the step of: upon reception of a notification from said control station informing that the operation mode is changed, displaying the notification in display means provided in said communication station as a reception station.

With this arrangement, the change of the operation mode of the transmission station can be seen in the reception station.

Further, in addition to the foregoing arrangement, the communication management method of the present invention may further comprise the step of: requesting change of the operation mode of said transmission station to the high-speed transmission mode or to the low-speed transmission mode.

With this arrangement, the operation mode of the transmission station may be changed also at the reception station.

A communication station according to the present invention is provided in a communication system that is made up of a plurality of communication stations and a control station for controlling transmission rights of said communication stations, said communication station comprising: a transmission and/or a reception section for transmitting and/or receiving information to/from said communication stations and said control station; and a scheduling section for carrying out the foregoing communication management method of the present invention.

With this arrangement, a communication station for realizing the present invention may be provided.

A communication management method according to the present invention is performed by a control station for controlling a transmission right of a communication station operating as a transmission station for carrying out the foregoing communication management method of the present invention, said method comprising the step of: displaying in display means provided in said control station a current operation mode of said transmission station.

With this arrangement, the operation mode of the transmission station may be changed at the control station.

A communication station according to the present invention is provided in a communication system that is made up of a plurality of communication stations and said control station for controlling transmission rights of said communication stations, said control station comprising: a reception section for receiving requests for transmission right from said plurality of communication stations; a transmission section for providing transmission rights to at least a part of said communication stations; and a scheduling section for carrying out the foregoing communication management method of the present invention.

With this arrangement, a control station for realizing the present invention may be provided.

Further, a communication management program according to the present invention causes a computer to carry out the foregoing communication management method of the present invention.

Further, a storage medium according to the present invention stores the foregoing communication management program of the present invention.

By downloading the foregoing program into a computer system, the communication management method of the present invention may be provided to the user.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a flow chart showing operation procedure of a method for realizing effective use of communication band, according to a communication management system of the present invention.

FIGS. 2(a) and 2(b) are explanatory views showing a periodic interval for the communication management system of the present invention.

FIGS. 3(a) and 3(b) are explanatory views showing another periodic interval for the communication management system of the present invention.

FIG. 4 is an explanatory view showing data transmission in the communication management system of the present invention.

FIG. 5 is an explanatory view showing operation procedure of a method for realizing effective use of communication band, according to another communication management system of the present invention.

FIG. 6 is an explanatory view showing operation procedure of another method for realizing effective use of communication band, according to the communication management system of the present invention.

FIG. 7 is a flow chart showing operation procedure of the communication management system of FIG. 6.

FIG. 8 is an explanatory view for showing the lower limit, the reference value and the upper limit of TXOP in the communication management system of the present invention.

FIG. 9 is an explanatory view showing procedure of the communication management system.

FIG. 10 is an explanatory view showing a specific example of TXOP for each Ack Policy.

FIG. 11 is a flow chart showing operation procedure of the communication management system of FIG. 9.

FIG. 12 is an explanatory view showing the relation between the number of transmission stations and the physical rate.

FIG. 13 is a block diagram showing a structure example of a control station used for the communication management system.

FIG. 14 is a block diagram showing a structure example of a scheduling section of the control station.

FIG. 15 is a block diagram showing a structure example of a transmission station used for the communication management system.

FIG. 16 is a block diagram showing a structure example of a reception station used for the communication management system.

FIG. 17 is an explanatory view showing various patterns of mode change of the control station.

FIG. 18 is an explanatory view showing operation procedure example of making setting of a station number priority mode for a control/transmission station by the user.

FIG. 19 is a flow chart showing operation procedure example in a control station regarding change of operation mode of the control station.

FIG. 20 is a flow chart showing operation procedure example in a reception station regarding change of operation mode of the control station.

FIG. 21 is an explanatory view showing operation procedure example in which the user specifies the station number priority mode for the operation mode of the control station via the reception station so that a mode change request signal is transmitted to the control/transmission station.

FIG. 22 is an explanatory view showing operation procedure example of making setting of a station number priority mode for a control/reception station by the user.

FIG. 23 is a flow chart showing operation procedure example in a transmission station regarding change of operation mode of the control station.

FIG. 24 is an explanatory view showing an operation procedure example in which the user specifies the station number priority mode for the operation mode of the control station via the transmission station so that a mode change request signal is transmitted to the control/reception station.

FIG. 25 is an explanatory view showing operation procedure example of making setting of the station number priority mode for the control station via the control station by the user.

FIG. 26 is an explanatory view showing an operation procedure example in which the user specifies the station number priority mode for the operation mode of the control station via the transmission station so that a mode change request signal is transmitted to the control station.

FIG. 27 is an explanatory view showing an operation procedure example in which the user specifies the station number priority mode for the operation mode of the control station via the reception station, so that a mode change request signal is transmitted to the transmission station, and the transmission station further transmits the mode change request signal to the control station.

FIG. 28 is an explanatory view showing various patterns of mode change of the transmission station.

FIG. 29 is an explanatory view showing operation procedure example of making setting of a high-speed transmission mode for a control/transmission station by the user.

FIG. 30 is a flow chart showing operation procedure example in a transmission station regarding change of operation mode of the transmission station.

FIG. 31 is a flow chart showing operation procedure example in a reception station regarding change of operation mode of the transmission station.

FIG. 32 is an explanatory view showing operation procedure example of making setting of a high-speed transmission mode for a transmission station by the user.

FIG. 33 is an explanatory view showing another operation procedure example of making setting of a high-speed transmission mode for a transmission station by the user.

FIG. 34 is a flow chart showing operation procedure example in a control station regarding change of operation mode of the transmission station.

FIG. 35 is an explanatory view showing an operation procedure example in which the user specifies the high-speed transmission mode for the operation mode of the control/transmission station via the reception station so that a mode change request signal is transmitted to the control/transmission station.

FIG. 36 is an explanatory view showing an operation procedure example in which the user specifies the high-speed transmission mode for the operation mode of the transmission station via the control/reception station so that a mode change request signal is transmitted to the transmission station.

FIG. 37 is an explanatory view showing an operation procedure example in which the user specifies the station number priority mode for the operation mode of the transmission station via the reception station so that a mode change request signal is transmitted to the transmission station.

FIG. 38 is an explanatory view showing a signal flow in a conventional communication management system.

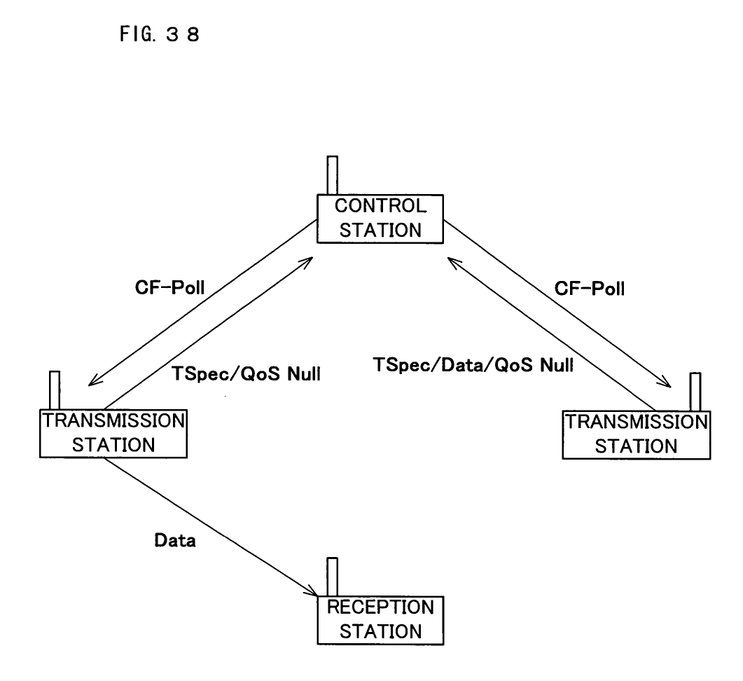

FIG. 39 is an explanatory view showing the relation between the transmission PHY rate and the transmission distance, and the relation between the transmission PHY rate and the transmission time.

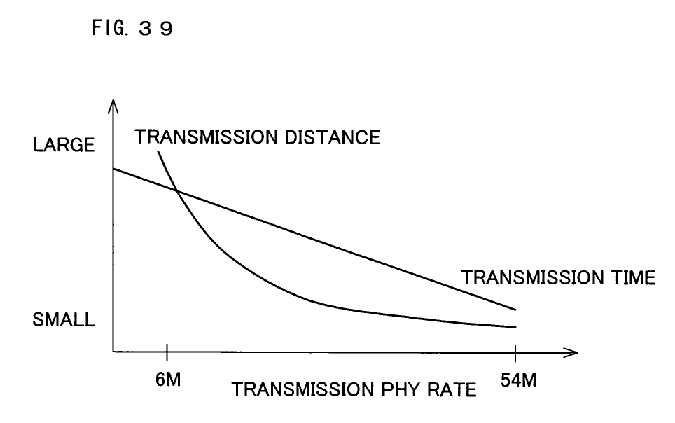

### BEST MODE FOR CARRYING OUT THE INVENTION

One embodiment of the present invention will be described below with reference to Figures.

A communication management system according to the present embodiment performs transmission (scheduling) of a CF-POLL to each communication station with a specified predefined period, that is periodically set in a continuous manner. With this arrangement, the communication management system needs to manage less quantity of TXOP information.

[Polling Interval]

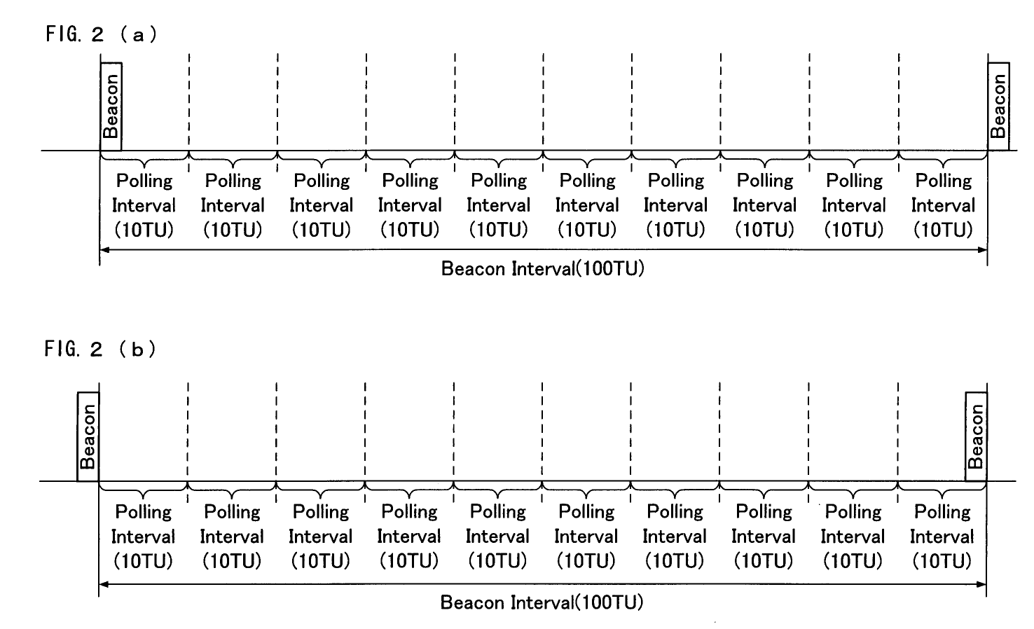

First, the following describes the periodicity (Polling Interval) of the foregoing communication management system with reference to FIGS. 2 through 4.

In a general communication using a wireless medium or the like, the control station transmits a packet called “Beacon” at certain intervals (Beacon Interval), so as to be synchronized in time with other communication stations.

In the present invention, a communication management system with periodicity is one of the following four kinds. Note that, the ITU corresponds to 1024 μs.

1) As shown in FIG. 2(a), in a system with the polling interval=10 TU and the beacon interval=100 TU, a polling interval begins upon transmission of Beacon, and continues at constant intervals.

2) As shown in FIG. 2(b) in a system with the polling interval=10 TU and the beacon interval=100 TU, a polling interval begins at the end of transmission of Beacon, and continues at constant 10 TU intervals.

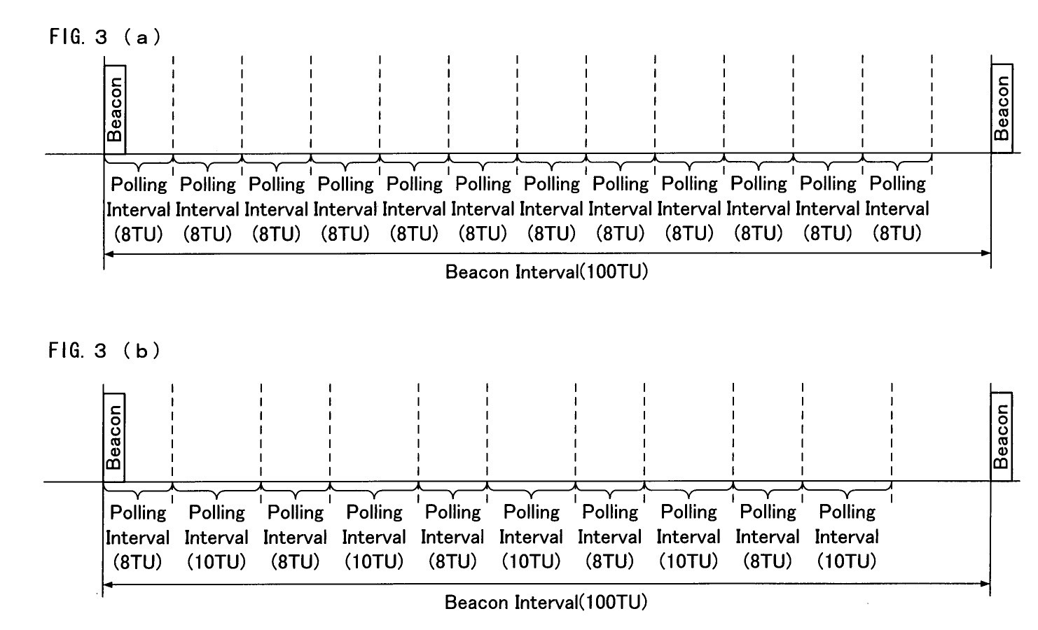

3) As shown in FIG. 3(a), in a system with the polling interval=8 TU and the beacon interval=100 TU, a polling interval begins upon transmission of Beacon, and continues at constant 8 TU intervals, with a blank time (vacant time) at the end of the beacon interval. 4) As shown in FIG. 3(a), in a system with the polling interval=8 TU and 10 TU, and the beacon interval=100 T U, a polling interval begins upon transmission of Beacon, and continues alternately at a 8 TU interval and a 10 TU interval.

[Operation of Communication Station]

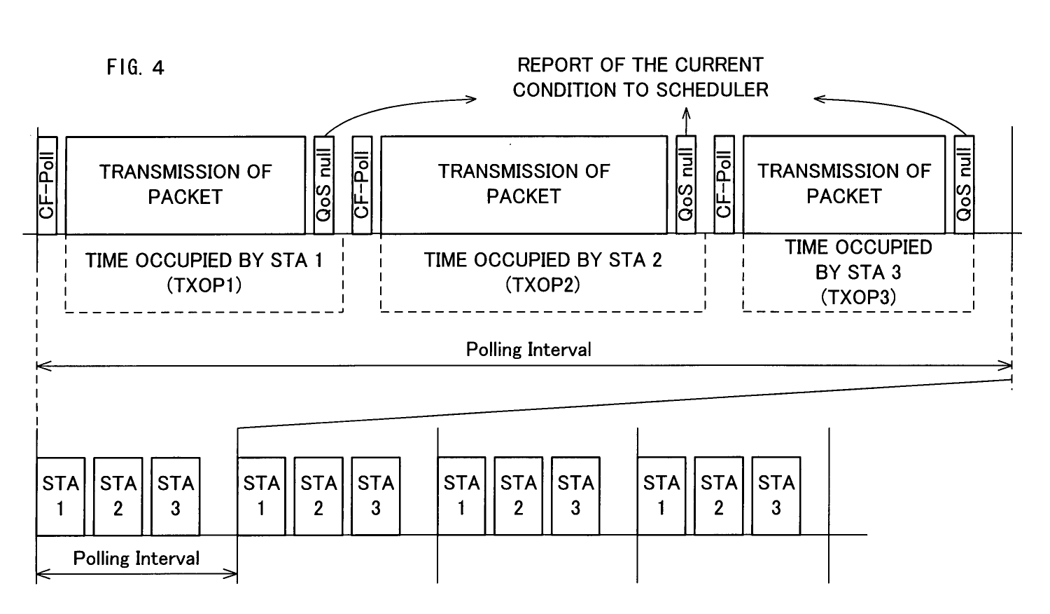

Next, with reference to FIG. 4, the following minutely describes operation of a communication station that has been given a TXOP. FIG. 4 shows an example with a plurality of communication stations (transmission station (STA) s 1 through 3). In this example, a transmission right is given to the communication stations in order of 1, 2 and 3.

As shown in FIG. 4, a transmission station 1, that has been given a transmission right by receiving a CF-Poll from a control station, transmits data (packet) to a reception station during the given period (TXOP1: time occupied by the transmission station 1). After the transmission of the data, the transmission station reports communication condition, such as buffering condition, to the control station via QoS Null.

Next, a transmission station 2, that has been given a transmission right by receiving a CF-Poll from the control station, transmits data (packet) to a reception station during the given period (TXOP2: time occupied by the transmission station 2). After the transmission of the data, the transmission station reports communication condition, such as buffering condition, to the control station via QoS Null.

Then, a transmission station 3, that has been finally given a transmission right at the end of the transmission right allotting period (polling interval) by receiving a CF-Poll from the control station, transmits data (packet) to a reception station during the given period (TXOP3: time occupied by the transmission station 3). After the transmission of the data, the transmission station reports communication condition, such as buffering condition, to the control station via QoS Null.

As can be seen in FIG. 4, when the transmission station 3 completes report of the communication condition to a scheduler of the control station via QoS Null during the polling interval after the data transmission is finished, there is produced a blank period until the transmission station 1 is given the next transmission right. That is, in this period, none of the transmission stations receive the transmission right.

Such a blank time may occur depending on the communication condition even when the provision of TXOP to each transmission station is arranged to consume the entire polling interval. Further, the blank time, that occurs at the end of the polling interval in the example of FIG. 4, may also occur after data transmission by the transmission station 1 or after data transmission by the transmission station 2.

Here, the following explains how the TXOPs should be allotted in the foregoing case where the polling interval includes a blank time, in view of effective use of the communication band.

In the present embodiment, allocation (provision) of TXOP is carried out again in the blank period.

As to the method for re-allotting TXOPs to transmission stations in the blank period, one of the followings is preferably used: (i) an allotting method based on the information reported through Qos Null, (ii) an allotting method based on the actual consumed time of the given TXOP, (iii) an allotting method based on information of priority, if it can be obtained, and (iv) a method using a combination of at least two of those (i) through (iii).

[Specific Example of the Method for Allotting TXOP]

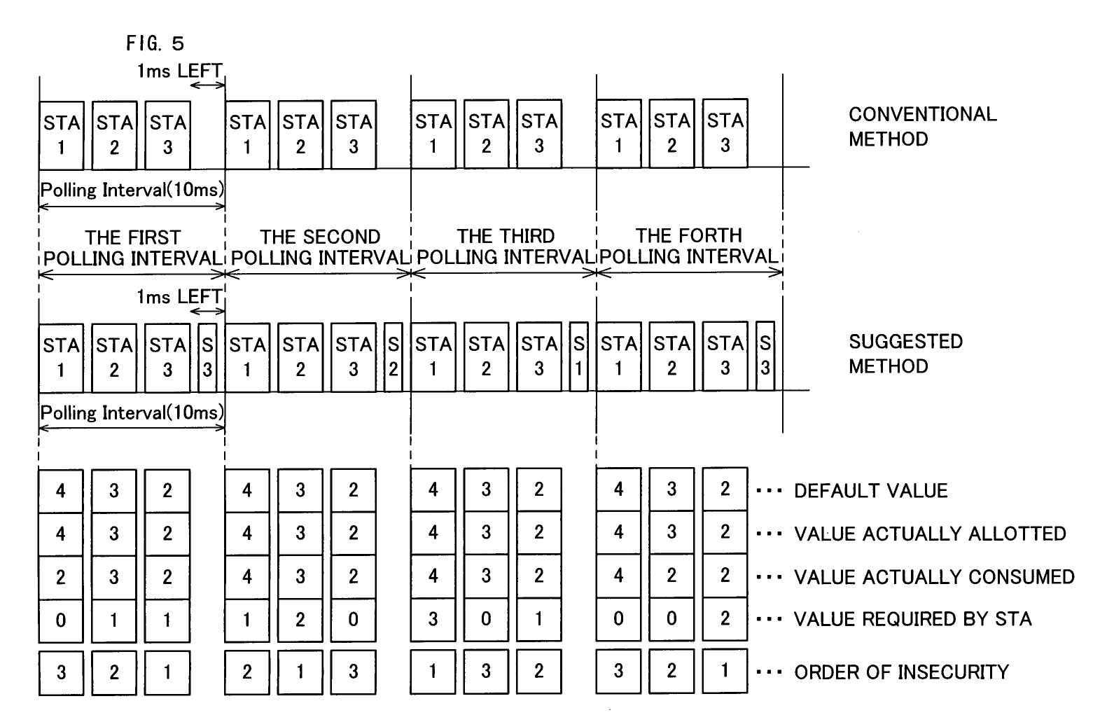

With reference to FIG. 5, the following explains a specific example of a method for enabling effective use of the communication band. Note that, FIG. 5 illustrates a communication management system according to the present invention in the middle stage, together with a conventional method in the upper stage provided for reference.

As shown in FIG. 5, the present example is arranged so that a TXOP is re-allotted during the blank period (1 ms in the example of FIG. 5), that occurs at the end of the polling interval (10 ms). The allocation is performed in the following manner (see the first polling interval through the fourth polling interval in the middle stage of FIG. 5).

The example of FIG. 5 has a plurality of transmission stations (STA 1 through 3). It should be noted that the present invention is not limited to this number of transmission stations but may be adopted for a system with four or more transmission stations. Further, though the example of FIG. 5 performs re-allocation of the blank period to only one of the transmission stations, the present invention may also be arranged so that the blank time is given to a plurality of transmission stations. Further, though the example of FIG. 5 contains the blank time at the end of the polling interval, the foregoing method may also be adopted for the case where the blank period exists after data transmission by the STA 1 or after data transmission by the STA 2.

More specifically, as shown in FIG. 5, it is assumed that the default values (values to be given) of the TXOP to the transmission stations 1 through 3 in the first polling interval are 4 ms, 3 ms and 2 ms, respectively, and the actual allotted lengths (the length having been actually given) of the respective TXOPs are 4 ms, 3 ms and 2 ms, respectively. Further, it is also assumed that the actually consumed times of TXOPs in the transmission stations 1 through 3 are 2 ms, 3 ms and 2 ms, respectively, and the requested TXOP lengths from the transmission station 1 through 3 via Qos Null (not shown) are 0 ms, 1 ms and 1 ms, respectively.

In this case, it is concluded that the communication condition of the first polling interval is the worst (in terms of insecurity) for the transmission station 3, followed by the transmission station 2, and then the transmission station 1; accordingly, a TXOP is re-allotted within the blank period to the transmission station 3 in the worst communication condition.

Note that, though the transmission stations 2 and 3 both demand a 1 ms request value, the communication condition is determined also in consideration of their default values. Namely, since the transmission station 2 has a default value of 3 ms, while the transmission station 3 has a default value of 2 ms, the ratio of the request value to the default value is greater for the transmission station 3 than the transmission station 2, and therefore it is concluded that the communication condition is worse in the transmission station 3 than the transmission station 2.

The second polling interval differs from the first polling interval in that the actually consumed times of TXOPs in the transmission stations 1 through 3 are 4 ms, 3 ms and 2 ms, respectively, and the requested TXOP lengths from the transmission station 1 through 3 via Qos Null (not shown) are 1 ms, 2 ms and 0 ms, respectively. In this case, it is concluded that the communication condition is the worst (in terms of insecurity) in the transmission station 2, followed by the transmission station 1, and then the transmission station 3; accordingly, a TXOP is re-allotted within the blank period to the transmission station 2 in the worst communication condition.

The third polling interval differs from the second polling interval in that the requested TXOP lengths from the transmission station 1 through 3 via Qos Null (not shown) are 3 ms, 0 ms and 1 ms, respectively. In this case, it is concluded that the communication condition is the worst (in terms of insecurity) in the transmission station 1, followed by the transmission station 3, and then the transmission station 2; and a TXOP is re-allotted within the blank period to the transmission station 1 in the worst communication condition.

The fourth polling interval differs from the third polling interval in that the actually consumed times of TXOPs in the transmission stations 1 through 3 are 4 ms, 2 ms and 2 ms, respectively, and the requested TXOP lengths from the transmission station 1 through 3 via Qos Null (not shown) are 0 ms, 0 ms and 2 ms, respectively. In this case, it is concluded that the communication condition is the worst (in terms of insecurity) in the transmission station 3, followed by the transmission station 2, and then the transmission station 1; accordingly, a TXOP is re-allotted within the blank period to the transmission station 3 in the worst communication condition.

As explained, the structure of the present embodiment securely prevents waste of the communication band, thereby securely realizing effective use of the communication band.

[Flow Chart of TXOP Providing Operation]

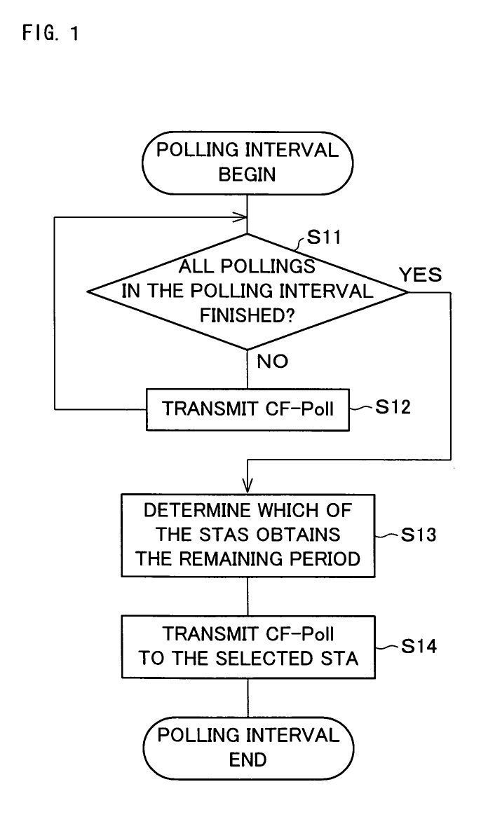

The following explains operation procedures of FIG. 5 with reference to FIG. 1.

First, upon start of polling interval, judgment is carried out as to whether or not the all polling operations in the polling interval are completed (S11). When the polling has not been completed, transmission of CF-Poll is carried out (S12), and the sequence goes back to S11.

On the other hand, when it is judged that the all polling operations are completed, the transmission station (STA) which will receive the blank (remaining) period is decided (S13). Then, a CF-Poll is transmitted to the selected transmission station (S14), and the polling interval is finished.

[Another Example of TXOP Allotting Method]

Here, the following describes another example of allotting method to more specifically explain how the TXOP should be allotted to realize effective use of communication band in consideration of communication conditions of the respective transmission stations.

This example uses a method for reflecting the information of Qos Null, that has been reported in the polling interval, to the scheduling of the next polling interval.

In the present embodiment, allocation (provision) of TXOP is performed so that the blank period does not occur in the second and later polling intervals.

The method for reflecting the information of Qos Null to the scheduling of the next polling interval, one of the followings is preferably used: (i) an allotting method based on the information reported through Qos Null, (ii) an allotting method based on the actual consumed time of the given TXOP, (iii) an allotting method based on information of priority, if it can be obtained, and (iv) a method using a combination of at least two of those (i) through (iii).

[Specific Example of TXOP Allotting Method]

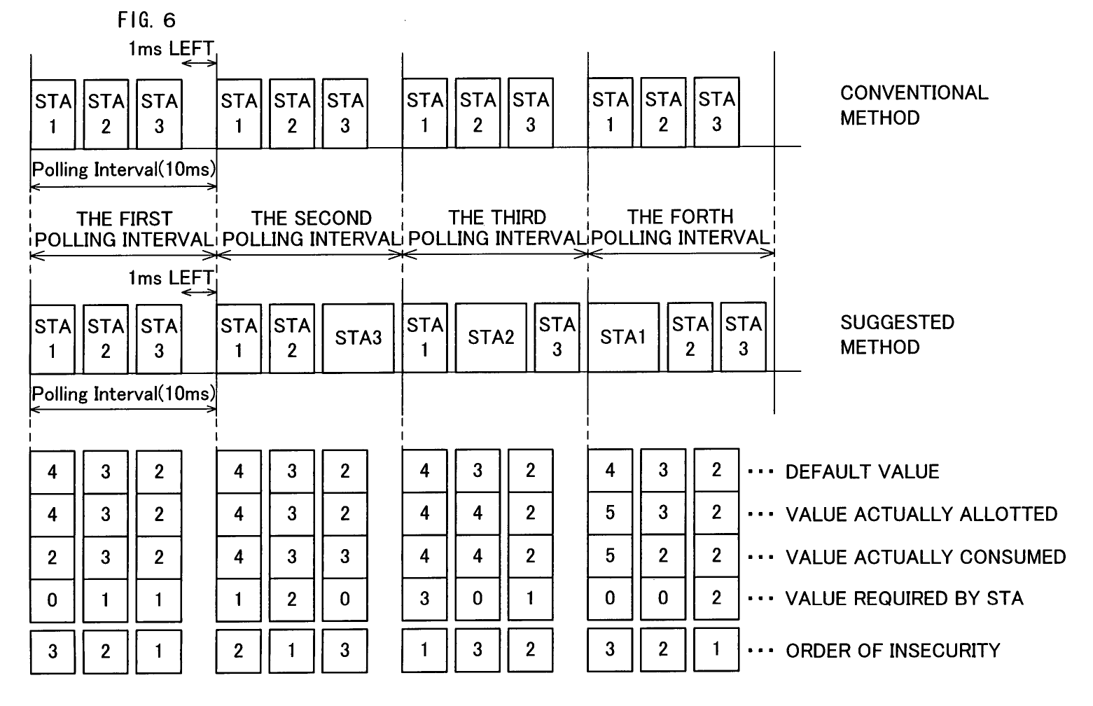

Here, the following specifically explains how to realize effective use of communication band with reference to FIG. 6. Note that, in FIG. 6, a communication management system according to the present invention is illustrated in the middle stage, together with a conventional method in the upper stage provided for reference.

As shown in FIG. 6, in this example, the report of Qos Null given in the first polling interval (10 ms) is reflected to the scheduling of the second polling interval. In this manner, the respective transmission stations of each polling interval are provided with TXOPs with the lengths modified in accordance with Qos Null.

The example of FIG. 6 has a plurality of transmission stations (STA 1 through 3). It should be noted that the present invention is not limited to this number of transmission stations but may be adopted for a system with four or more transmission stations. Further, though the example of FIG. 6 modifies the transmission right with respect to only one of the transmission stations, the present invention may also be arranged so that the transmission right is modified with respect to a plurality of transmission stations. Further, though the example of FIG. 6 shows the case of increasing the period of transmission right, the present invention may also be arranged to reduce the period. Further, though the example of FIG. 6 performs modification at the end of the polling interval, the modification may also be done after data transmission by the STA 1 or after data transmission by the STA 2.

More specifically, as shown in FIG. 6, it is assumed that the default values (values to be given) of the TXOP to the transmission stations 1 through 3 in the first polling interval are 4 ms, 3 ms and 2 ms, respectively, and the actual allotted lengths (the length having been actually given) of the respective TXOPs are 4 ms, 3 ms and 2 ms, respectively. Further, it is also assumed that the actually consumed times of TXOPs in the transmission stations 1 through 3 are 2 ms, 3 ms and 2 ms, respectively, and the requested TXOP lengths from the transmission station 1 through 3 via Qos Null (not shown) are 0 ms, 1 ms and 1 ms, respectively.

In this case, it is concluded that the communication condition of the first polling interval is the worst (in terms of insecurity) for the transmission station 3, followed by the transmission station 2, and then the transmission station 1; accordingly, the transmission station 3 is regarded the station in the worst communication condition in the first polling interval. This result is reflected upon modification of the TXOP of the transmission station 3 in the second polling interval.

Note that, though the transmission stations 2 and 3 both demand a 1 ms request value, the communication condition is determined also in consideration of their default values. Namely, since the transmission station 2 has a default value of 3 ms, while the transmission station 3 has a default value of 2 ms, the ratio of the request value to the default value is greater for the transmission station 3 than the transmission station 2, and therefore it is concluded that the communication condition is worse in the transmission station 3 than the transmission station 2.

In the second polling interval, the actual given length of TXOP to the transmission station 3 is increased from 2 ms to 3 ms. Further, the actually consumed times of TXOPs in the transmission stations 1 through 3 are 4 ms, 3 ms and 3 ms, respectively, and the requested TXOP lengths from the transmission station 1 through 3 via Qos Null (not shown) are 1 ms, 2 ms and 0 ms, respectively. In this case, it is concluded that the communication condition is the worst (in terms of insecurity) for the transmission station 2, followed by the transmission station 1, and then the transmission station 3; accordingly, the transmission station 2 is regarded the station with the worst communication condition in the second polling interval. This result is reflected upon modification of the TXOP of the transmission station 2 in the third polling interval.

In the third polling interval, the actual given length of TXOP to the transmission station 2 is increased from 3 ms to 4 ms, while the same for the transmission station 3 is decreased from 3 ms to 2 ms. Further, the actually consumed times of TXOPs in the transmission stations 1 through 3 are 4 ms, 4 ms and 2 ms, respectively, and the requested TXOP lengths from the transmission station 1 through 3 via Qos Null (not shown) are 3 ms, 0 ms and 1 ms, respectively. In this case, it is concluded that the communication condition is the worst (in terms of insecurity) for the transmission station 1, followed by the transmission station 3, and then the transmission station 2; accordingly, the transmission station 1 is regarded the station in the worst communication condition in the third polling interval. This result is reflected upon modification of the TXOP of the transmission station 1 in the fourth polling interval.

In the fourth polling interval, the actual given length of TXOP to the transmission station 1 is increased from 4 ms to 5 ms, while the same for the transmission station 2 is decreased from 4 ms to 3 ms. Further, the actually consumed times of TXOPs in the transmission stations 1 through 3 are 5 ms, 2 ms and 2 ms, respectively, and the requested TXOP lengths from the transmission station 1 through 3 via Qos Null (not shown) are 0 ms, 0 ms and 2 ms, respectively. In this case, it is concluded that the communication condition is the worst (in terms of insecurity) for the transmission station 3, followed by the transmission station 2, and then the transmission station 1; accordingly, the transmission station 3 is regarded the station in the worst communication condition in the fourth polling interval. This result is reflected upon modification of the TXOP of the transmission station 3 in the next polling interval (not shown).

As explained, the structure of the present embodiment securely prevents waste of the communication band, thereby realizing effective use of the communication band, as well as allocation of the transmission rights according to the communication conditions of the respective communication stations.

[Flow Chart of TXOP Providing Operation]

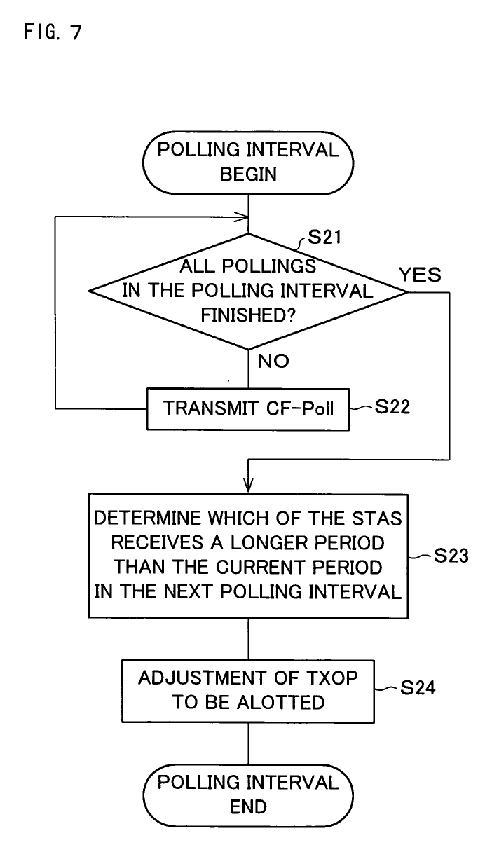

The following explains the foregoing operation procedures with reference to FIG. 7.

First, upon start of polling interval, judgment is carried out as to whether or not the all polling operations in the polling interval are completed (S21). When the polling has not been completed, transmission of CF-Poll is carried out (S22), and the sequence goes back to S21. On the other hand, when it is judged that the all polling operations are completed, decision is made as to which of the transmission station (STA) receives a larger length (TXOP) of transmission right than the current length in the next polling interval (S23). Then, the respective TXOPs to be given are adjusted (S24), and the polling interval is finished.

As described, in the foregoing communication management method of the present embodiment, when a plurality of communication stations are present with respect to the control station, the period of transmission right to be given is specified in length not to exceed an upper limit or fall below a lower limit, which limits are determined for each communication station. With this arrangement, it is possible to prevent a communication station in a bad communication condition from affecting a communication station in a tolerable condition, while securely avoiding in advance a scheduling giving a period exceeding the polling interval.

[Specific Example of Communication Management System]

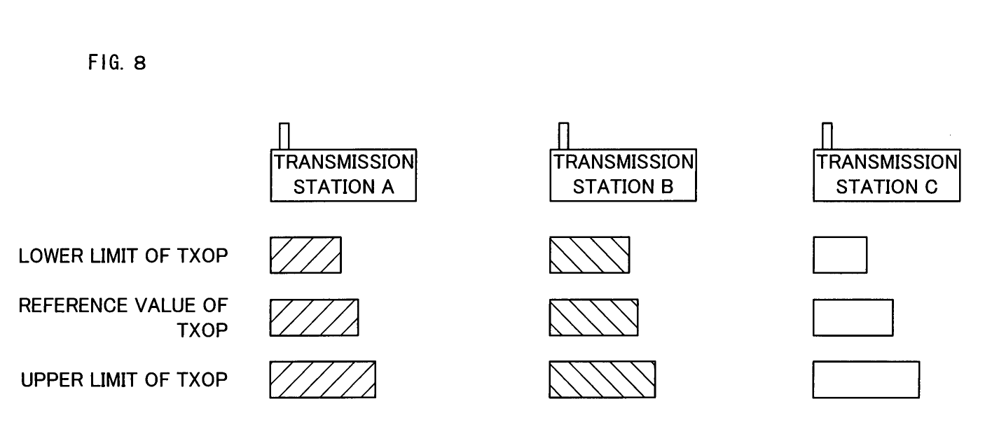

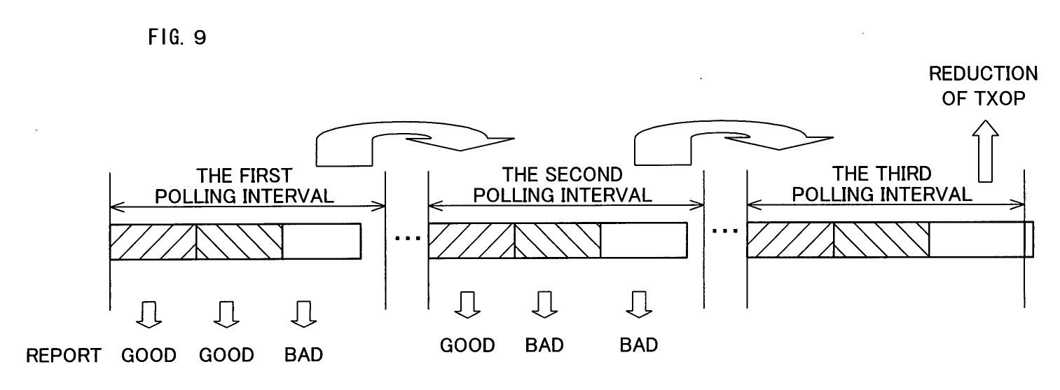

Here, the following describes a specific example of the foregoing communication management system with reference to FIGS. 8 and 9.

First process is definition of stream, followed by negotiation by the transmission stations (A through C) to the control station before the stream actually flows. More specifically, the transmission stations (A through C) make request for, such as transmission of a kind of data in a jitter range, to the control station before the stream actually starts flowing. After the negotiation between the transmission stations and the control station, the control station determines the lower limit and the upper limit of the TXOP given to the transmission station according to the content of data and the jitter range etc. also in consideration of fluctuation of physical rate (see FIG. 8).

More specifically, since the physical rate varies for each transmission station, the control station cannot identify the physical rate at the time of the definition of stream. Therefore, the control station sets the physical rate to an intermediate value (corresponding to the reference value of TXOP) of a possible physical rate range, and further sets the lower limit and the upper limit in consideration of the case of a physical rate greater or smaller than the decided intermediate value. Note that, in normal operation, the control station does not provide a TXOP falling below the lower limit or a TXOP exceeding the upper limit when the values of the upper limit and the lower limit are thus decided.

In the first polling interval shown in FIG. 9, a transmission station A, that has been given a transmission right by receiving a CF-Poll (not shown) from the control station (not shown), transmits data (packet) to a reception station (not shown) during the given period (TXOP: time occupied by the transmission station A). After the transmission of the data, the transmission station A reports communication condition to a scheduler of the control station via QoS Null. For ease of explanation, it is assumed in the present example that the report tells a good result.

Next, a transmission station B, that has been given a transmission right by receiving a CF-Poll from the control station, transmits data (packet) to a reception station during the given period (TXOP: time occupied by the transmission station B). After the transmission of the data, the transmission station B reports communication condition to the scheduler of the control station via QoS Null. For ease of explanation, it is assumed here that the report tells a good result.

Then, in the final period of the first polling interval, a transmission station C, that has been given a transmission right by receiving a CF-Poll from the control station, transmits data (packet) to a reception station during the given period (TXOP: time occupied by the transmission station C). After the transmission of the data, the transmission station C reports communication condition, such as buffer condition, to the scheduler of the control station via QoS Null. For ease of explanation, it is assumed here that the report tells a bad result. In this case, the transmission station C demands a long TXOP to the scheduler.

Thereafter, the schedule is updated and the second polling interval begins. In the second polling interval, the schedule is updated according to the result of report in the first polling interval.

More specifically, according to the good result of the report in the first polling interval, the transmission station A is provided in the second polling interval with a TXOP of the same or a shorter length than the TXOP given in the first polling interval. After the transmission of the data, the transmission station A reports communication condition to the scheduler of the control station via QoS Null. Here, it is assumed that the report tells a good result.

Next, according to the good result of the report in the first polling interval, the transmission station B is provided in the second polling interval with a TXOP of the same or a shorter length than the TXOP given in the first polling interval. After the transmission station B having been given the transmission right transmits the data, communication condition is reported to the scheduler of the control station by the transmission station B via QoS Null. Here, it is assumed that the report tells a bad result. In this case, the transmission station B demands a long TXOP to the scheduler.

According to the bad result of the report in the first polling interval, the transmission station C is provided in the second polling interval with a TXOP of a longer length than the prior TXOP (TXOP given in the first polling interval). After the transmission station C having been given the transmission right transmits the data, communication condition is reported to the scheduler of the control station by the transmission station C via QoS Null. Here, it is assumed that the report tells a bad result. In this case, the transmission station C demands a longer TXOP than that of the second polling interval to the scheduler.

Thereafter, the schedule is updated and the third polling interval begins. In the third polling interval, the schedule is updated according to the result of report in the second polling interval.

More specifically, in the third polling interval shown in FIG. 9, according to the good result of the report in the second polling interval, the transmission station A is provided with a TXOP of the same or a shorter length than the TXOP given in the second polling interval. After the transmission station B having been given the transmission right transmits the data, communication condition is reported to the scheduler of the control station by the transmission station B via QoS Null.

Next, according to the bad result of the report in the second polling interval, the transmission station B is provided in the third polling interval with a TXOP of a longer length than the TXOP given in the second polling interval according to the request. After the transmission station B having been given the transmission right transmits the data, communication condition is reported to the scheduler of the control station by the transmission station B via QoS Null.

According to the bad result of the report in the second polling interval, the transmission station C is provided in the third polling interval with a TXOP of a longer length than the prior TXOP (TXOP given in the second polling interval) according to the request.

However, with the length of TXOP requested by the transmission station C in the second polling interval, the total length of the respective TXOPs of the transmission stations A through C exceeds the period of the third polling interval. Therefore, if the TXOP is given to the transmission station C with the required length, it exerts some bad influence on the transmission stations A and B (other transmission stations in a tolerable communication condition) whose length of TXOP maintains the range within the upper limit determined in FIG. 8.

In view of this problem, the present embodiment is arranged so that, when the total TXOP length exceeds the period of the polling interval (as with the third polling interval in FIG. 9), the schedule is controlled by modifying the length to be given to one of the transmission stations A through C that has requested a value (length) that most greatly differs from the reference value of TXOP. Specifically, in the case of FIG. 9, the system regards that the transmission station C is in a singularly bad communication condition, and the TXOP for the transmission station C is reduced.

In other words, according to the present embodiment, when the requested TXOP length by the transmission station C has the larger difference from its reference TXOP than any of the differences between the requested TXOP lengths by the other transmission stations and their corresponding reference values, the control station concludes that the transmission station C is in a singularly bad communication condition. Accordingly, the transmission station C is not provided with the required TXOP length in the third polling interval.

This arrangement disables the transmission station C to carry out desirable transmission, but previously prevents some bad influence exerted on the transmission stations A and B.

[Calculation of TXOP]

Here, the following shows how to calculate the TXOP. The reference value of the TXOP is found as follows.

Then, the mean data rate is expressed as M, the nominal MSDU size is expressed as S, the Ack Policy is expressed as P, the PHY (physic) rate for data transmission is expressed as RPHY, the ancillary length such as a MAC header is expressed as dheader, SIFS16us is expressed as TSIFS, the polling interval is expressed as TPI, the time taken to transmit QoS Null is expressed as Tnull, the time taken to transmit CF-Poll is expressed as Tpoll, the time taken to transmit 802.11Normal Ack is expressed as Tack, the time taken to request the Burst Ack is expressed as TBAR, and the time taken to transmit the Burst Ack is expressed as TBA.

Tnull through TBA can be found in advance, as their frame lengths and the rates are already known.

First, the mean data amount D of the data supposed to be transmitted within the polling interval TPI is calculated by D=M×TPI. Then, the number (N) for dividing the mean data amount D into MSDU (data) is found by N=[D/S]. The bracket [ ] denotes roundup of the result. Further, TPacket, that is the transmission time for 1 packet, is calculated by TPacket=(dheader+S)÷RPHY.

Next, the reference value of TXOP is calculated in consideration of the Ack method in accordance with the Ack policy. Specifically, in the case of 802.11 Normal Ack, reference value of TXOP=Tpoll+SIFS+Tack+(TSIFS+TPacket+TSIFS+TAck)×N+TSIFS+Tnull+TSIFS+Tack+TSIFS. In the case of No Ack, reference value of TXOP=Tpoll+(TSIFS+TPacket)×N+TSIFS+Tnull+TSIFS. In the case of Burst Ack, the reference value of TXOP=Tpoll+TSIFS+Tack+(TSIFS+TPacket)×N+TSIFS+TBAR+TSIFS+TBA+TSIFS+Tnull+TSIFS+Tack+TSIFS.

The control station may calculate the lower limit and the upper limit of TXOP separately by deciding the minimum and maximum values of the physical rate to be accepted, or may otherwise set the lower limit and the upper limit of TXOP to be several % of the reference value.

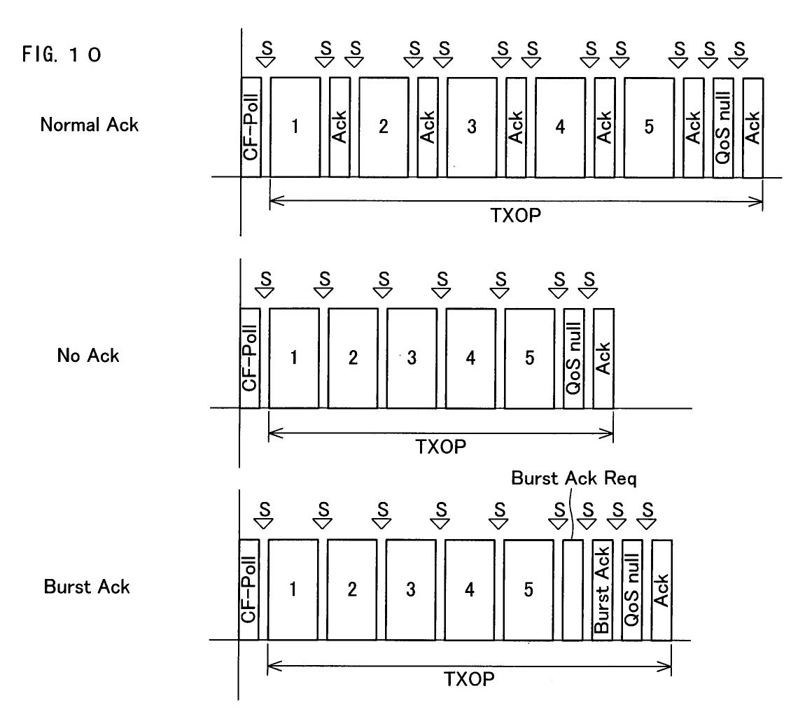

FIG. 10 is an explanatory view showing a specific example of the TXOP for each Ack policy P. In the figure, reference numerals 1 through 5 denote packets.

[Flow Chart of the TXOP Setting Process]

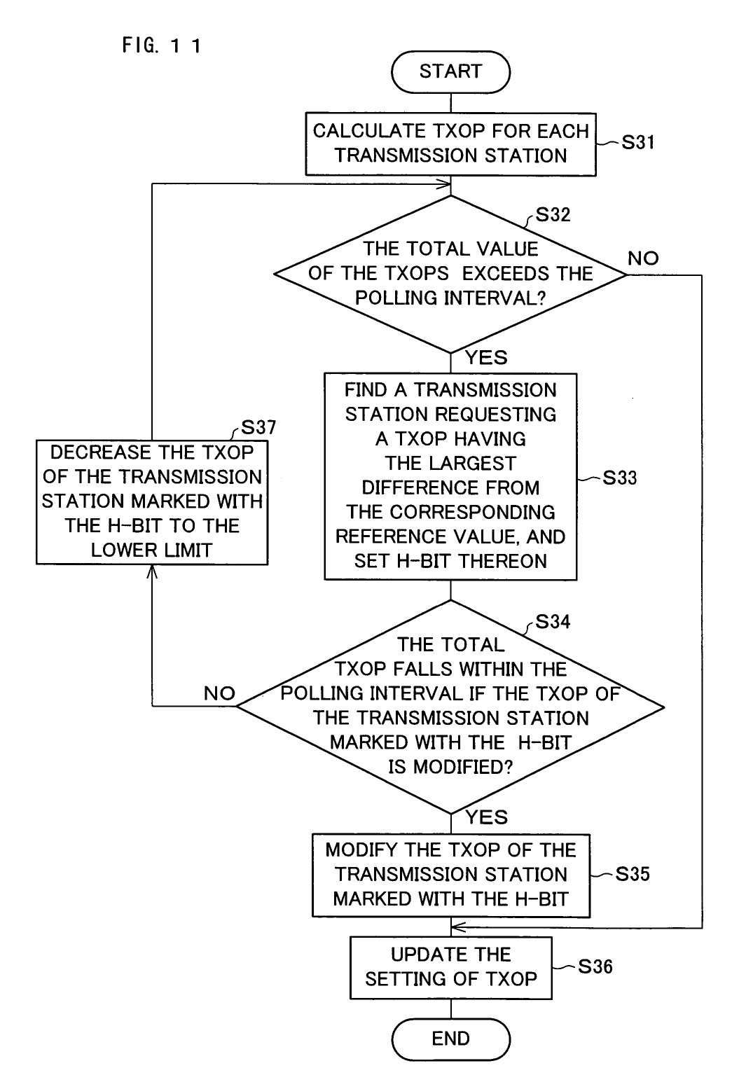

Here, with reference to FIG. 11, the following explains provision of TXOP in the foregoing scheduling operation.

First, the respective Qos Nulls of the transmission stations are received, and the requested TXOP is calculated for each transmission station (S31). However, if the calculation result exceeds the upper limit or falls below the lower limit, it is automatically decreased/increased to the upper limit/lower limit. Then, judgment is carried out as to whether or not the total value of the TXOP thus calculated exceeds the polling interval (S32). When it is judged in S32 that the total value of the TXOP exceeds the polling interval, the sequence goes to S33 to find a transmission station requesting a TXOP that most greatly differs from the reference value. Then, the picked transmission station is marked by setting the corresponding bit to H. Thereafter, the sequence goes to S34.

In S34, judgment is carries out as to whether the total TXOP falls within the polling interval if the TXOP of the transmission station marked with the H-bit is modified. If it is judged that the total value of the TXOP falls within the polling interval, the sequence goes to S35 to modify the TXOP of the transmission station marked with the H-bit, and then updates the setting of TXOP (S36).

On the other hand, if it is judged that the total value of the TXOP falls outside the polling interval, the sequence goes to S37 to decrease the TXOP of the transmission station marked with the H-bit to the lower limit. Consequently, the transmission station marked with the H-bit will not receive the requested amount of TXOP, thus failing to carry out desirable data transmission. The transmission station however is guaranteed data transmission with a period of the lower limit.

[Mode Setting]

Further, as mentioned above, increasing the transmission distance and supporting a large number of transmission stations conflict with each other. In this view, when providing the TXOPs to the transmission stations, the described prior art has no guideline to refer to the user's intention to decide whether the priority should be given to the distance of TXOP or should be given to the support for a plurality of transmission stations. Further, when the control station is operated with priority on the distance and therefore provides a great length of TXOP to the first transmission station to support its transmission stream, there is no way to inform the user of the resulting shortage of TXOP and the fact that the control station cannot support the second or third transmission stream, i.e., the control station cannot enable the second or third transmission station to be connected to the network.

In view of this problem, the present embodiment is arranged to enable the user to choose the operation mode between a distance priority mode and a station number priority mode. On this account, the user can carry out desirable mode setting.

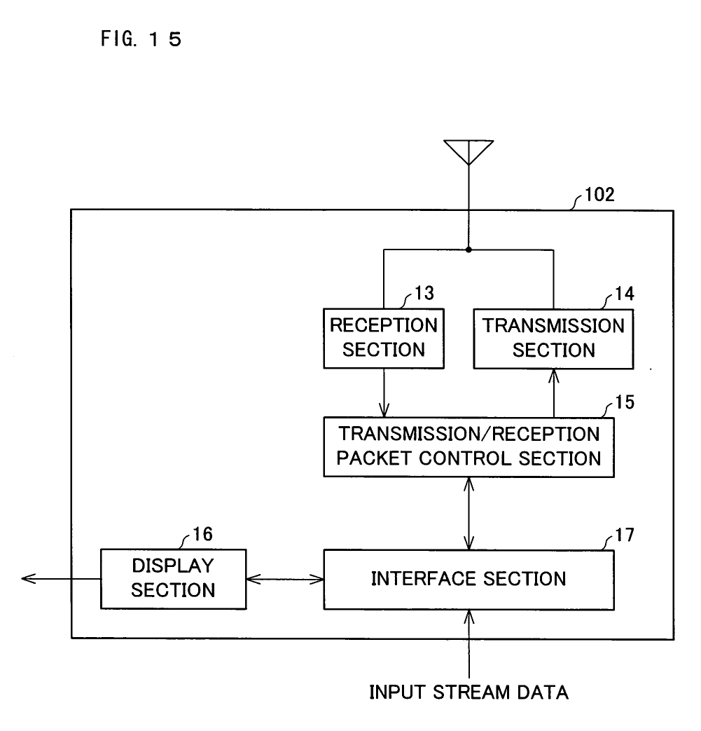

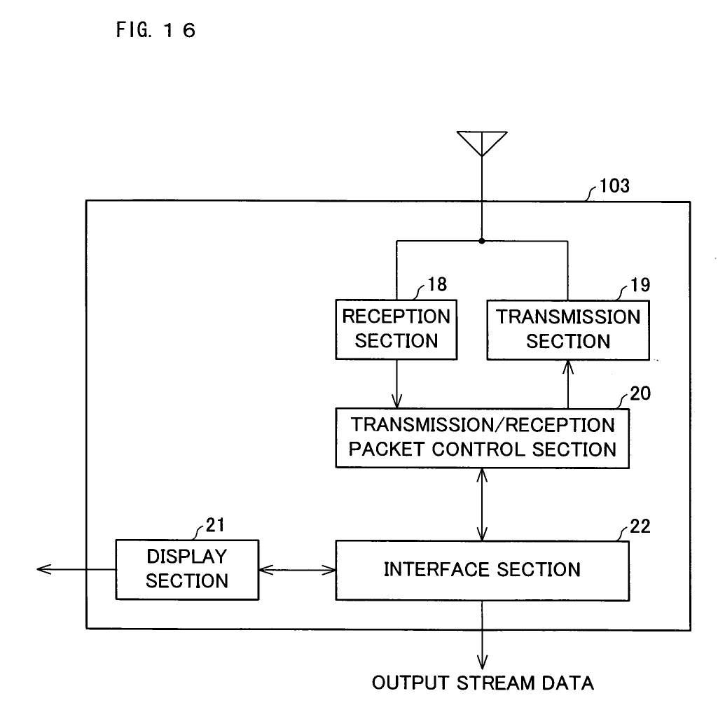

Further, the present embodiment is further arranged so that each communication station is informed of the current mode, i.e., one of the distance priority mode and the station number priority mode, in the corresponding display section (see the display section 14 of FIG. 15 and the display section 19 of FIG. 16). With this arrangement, the user can see in the corresponding terminal which of the distance priority mode or the station number priority mode is currently selected, and therefore is allowed to quickly take an appropriate action (e.g. cessation of the scheduling operation, change of setting to a desired control mode).

To be more specific, if the second and later transmission stations (streams) are shut out from the wireless network when the system is operated in the displace priority mode, the monitor (the display section) etc. of the communication station displays the message like “the second and later transmission stations (streams) cannot enter the network due to a line problem”. With this display, the user can be aware that the system is controlled with distance priority (in the distance priority mode) or with station number priority (in the station number priority mode), and therefore is allowed to take an appropriate action, such as change of the current control mode to more appropriate mode.

[Specific Example of Mode Setting]

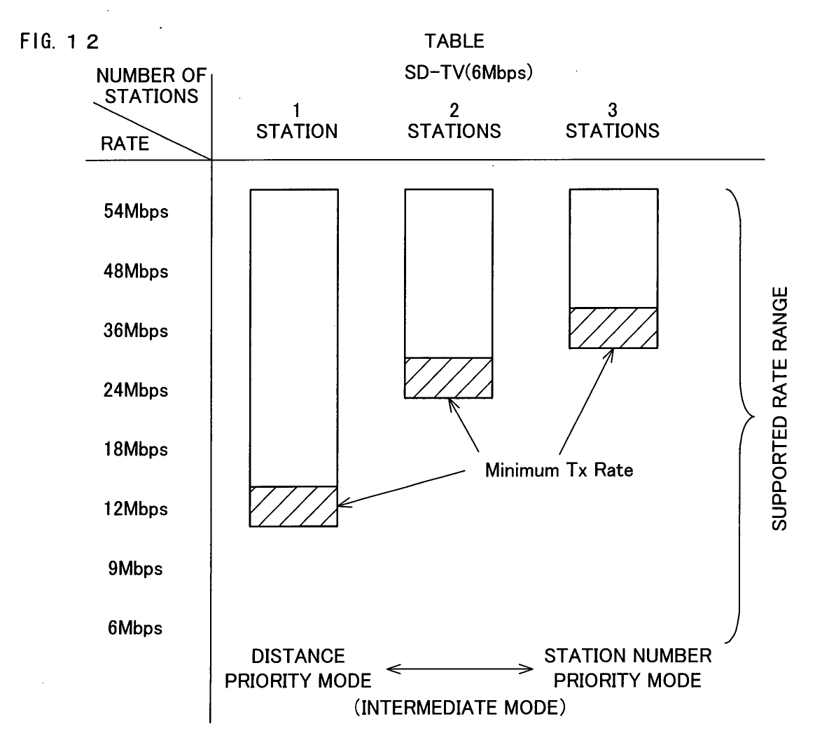

Here, a specific example of the foregoing mode setting is explained with reference to FIG. 12. The example of FIG. 12 are provided with up to three SD-TVs (6 Mbps) as transmission stations, and uses a physical rate (transmission PHY rate) of 6 Mbps-54 bps, that is an allowable range for IEEE802.11a. However, the present invention is not limited to this arrangement, and other combinations of the station number and the physical rate may be adopted.

As shown in FIG. 12, when only one transmission station exists, transmission can be easily carried out with the physical rate of 12 Mbps, allowing the transmission station to carry out long-distance transmission. However, the physical rate of 12 Mbps cannot support the transmission of two transmission stations, as it requires at least the physical rate of 24 Mbps. Further, the physical rate of 24 Mbps cannot support the transmission of three transmission stations, as it requires at least 36 Mbps. Namely, supporting a larger number of transmission stations brings about decrease of transmittable distance, i.e., having a longer transmission distance brings about decrease of the supportable number of transmission station. The mode setting should be carried out in consideration of this relation.

[Specific example of handling fluctuation of physical rate] Here, the following minutely explains a specific example to cope with an automatic change of the transmission PHY rate at the application layer of transmission station.

This structure allows setting of a threshold value used for judgment as to whether the control station can accepts (permits) the minimum transmission rate (minimum Tx rate), that is the minimum value of the transmission PHY rate of the transmission station (Sender), at the control station (Central control station: HC), thus allowing the user to set the threshold value to an appropriate value for the desired usage. The control station does not accept (permit) a request of stream from a transmission station if the minimum transmission rate is less than the threshold value.

After acceptance (permission) of the minimum transmission rate, the control station ensure for the transmission station provision of TXOP allowing the transmission with the minimum transmission rate.

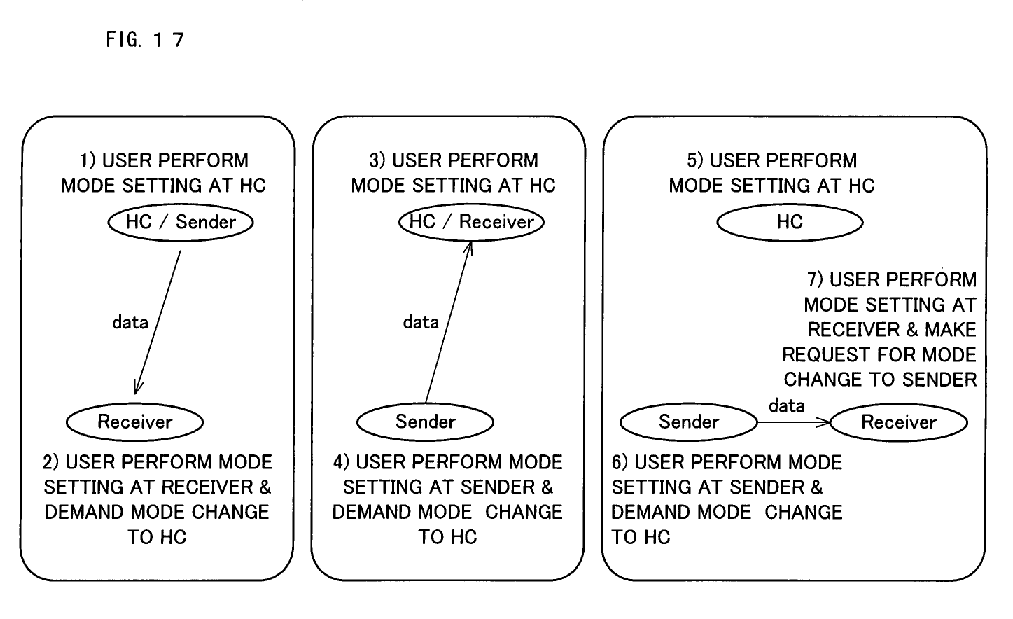

Further, the control station operates in the station number priority mode when the threshold is set to a high value, and operates in the distance priority mode when the threshold is set to a low value. The minimum transmission rate is previously stored in the control station in the form of a table; a specific example is shown in FIG. 12. As shown in FIG. 17, at least 7 ((1) through (7)) patterns can be assumed for the setting of the threshold value. The (1) through (7) patterns may respectively have optional arrangements, such as display of the mode of control station, display of notification of change (switching) of the mode of control station, display of notification and/or reason of rejection of the operation mode of control station (this is however only in the case where the request for a change of the operation mode is rejected). Note that, in the following explanation, the steps (1) through (7) in the respective drawings correspond to the patterns (1) through (7) of FIG. 17.

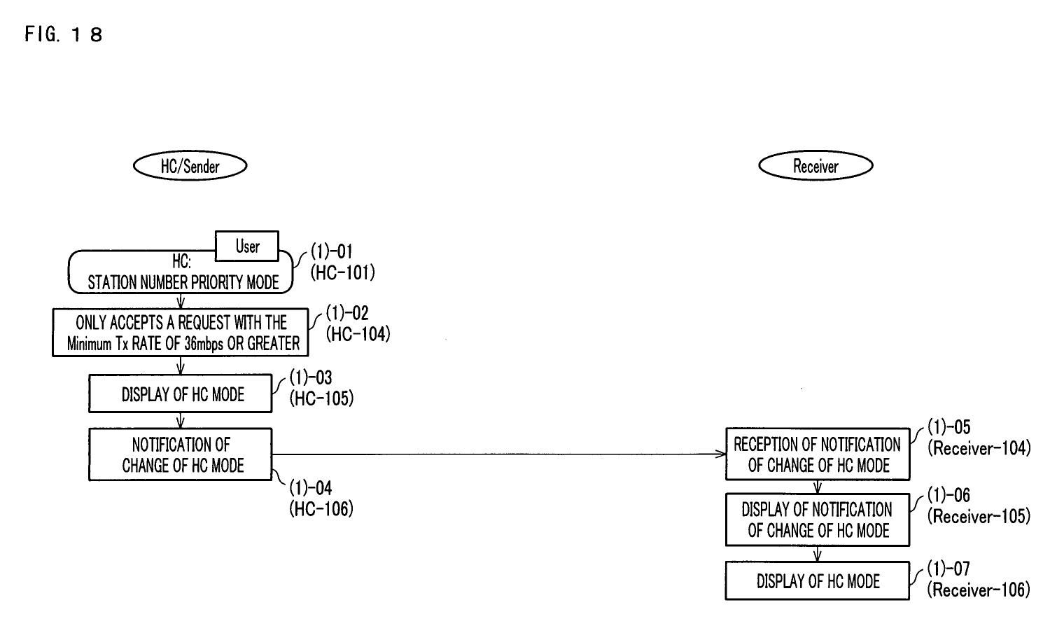

Here, with reference to FIGS. 18 through 20, the following describes a specific example (specific method for setting the operation mode of the control station to one of the station number priority mode and the distance priority mode) of setting the threshold value at the control station.

[Setting of Station Number Priority Mode (1)]

FIG. 18 shows an example where the user makes setting of the station number priority mode for a control/transmission station (HC/Sender). Note that, the control/transmission station functions as both the control station and the transmission station. For ease of explanation, it is assumed in this example that the threshold value corresponding to the station number priority mode is 36 Mbps.

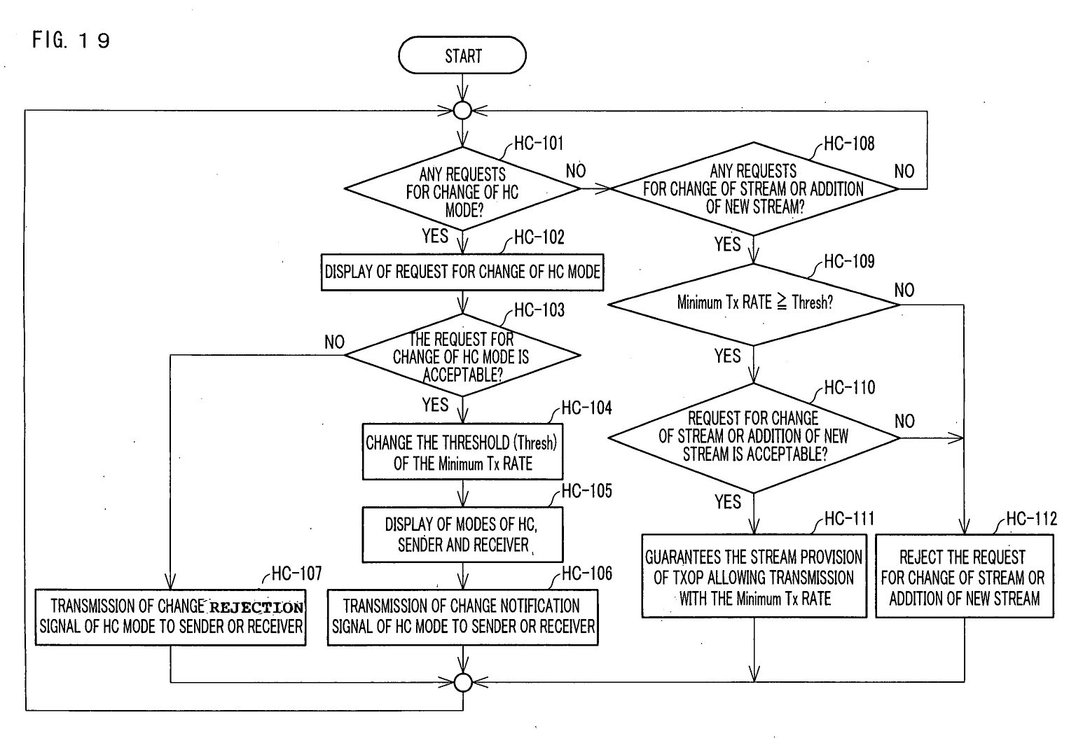

First, in the step (1)-01, the operation mode of the control station is set to the station number priority mode by the user (corresponding to the step HC-101 of FIG. 19). The user performs this step by, for example, selecting the station number priority mode through corresponding inputting means (e.g. push-button etc.).

Upon the selection through the inputting means, the threshold of the minimum transmission rate is set to, for example, 36 Mbps with reference to the afore-mentioned table (see FIG. 12) (corresponding to the step HC-104 of FIG. 19) at the control station. By so setting, the control station only accepts a request of stream from a transmission station with the minimum transmission rate of 36 Mbps or greater (Step (1)-02).

Then, in the step (1)-03, the change of operation mode of the control station is displayed in the control/transmission station (corresponding to the step HC-105 of FIG. 19). Then, in the step (1)-04, the control/transmission station informs a reception station (Receiver) that the operation mode of the control station has been changed to the station number priority mode (corresponding to the step HC-106 of FIG. 19).

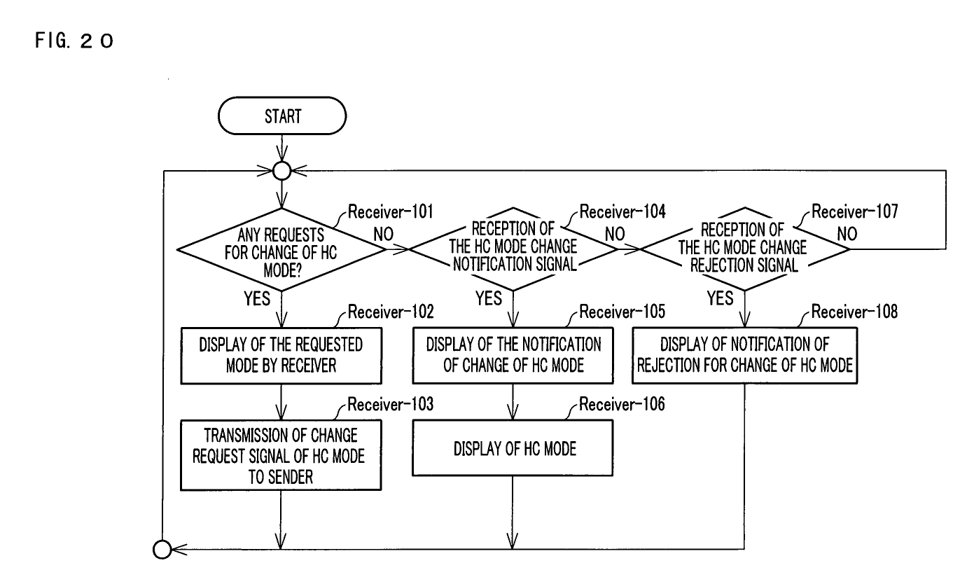

Upon reception of the notification of the change of setting into the station number priority mode from the control/transmission station in the step (1)-05 (corresponding to the step Receiver-104 of FIG. 20), the reception station displays in the step (1)-06 a message informing that the operation mode of the control station has been changed to the station number priority mode (corresponding to the step Receiver-105 of FIG. 20), and then further displays in the step (1)-07 a message informing that the control station operates in the station number priority mode (corresponding to the step Receiver-106 of FIG. 20).

Note that, the steps (1)-03 through (1)-07 are optional steps to provide displays enabling immediate recognition of the operation mode of the control station. Further, in the foregoing example, the steps (1)-01 and (1)-02 assume the case of the station number priority mode. When these steps are adopted for the distance priority mode, the control station only accepts a request of stream from a transmission station with the minimum transmission rate of, for example, 12 Mbps or greater, with reference to the foregoing table.

[Setting of Station Number Priority Mode (2)]

Here, with reference to FIGS. 19 through 21, the following describes another specific example of setting the operation mode of the control station to the station number priority mode.

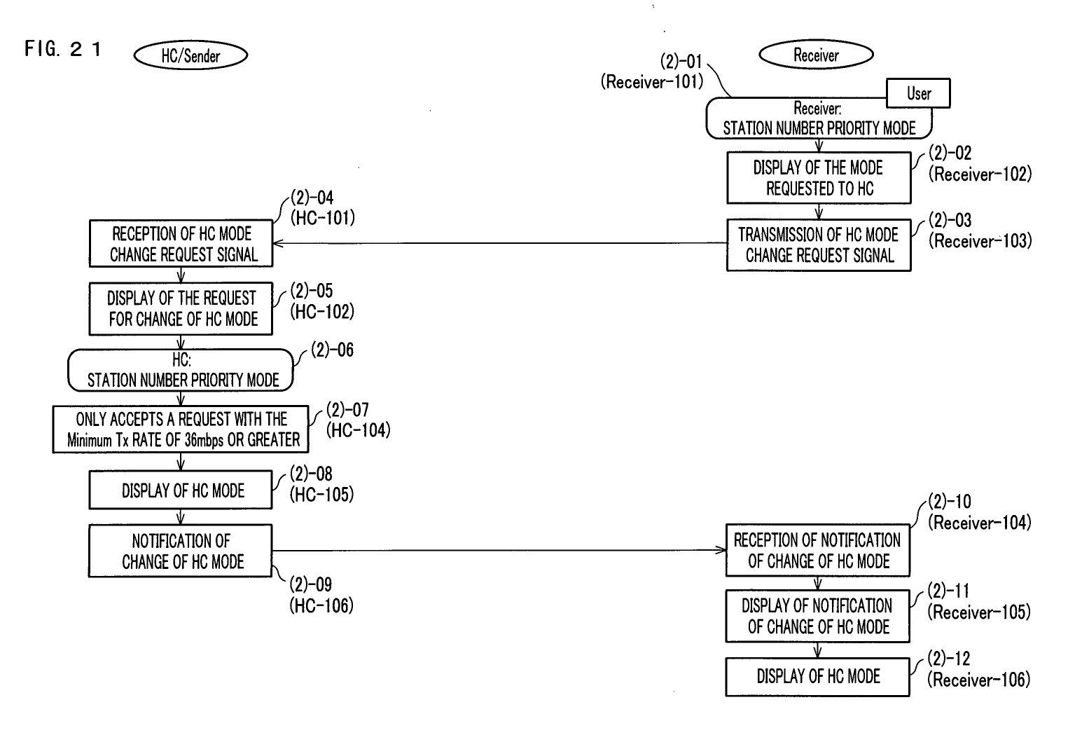

In the example of FIG. 21, the user specifies the station number priority mode for the operation mode of the control station, via a reception station (at the reception station), and then transmits a mode change request signal to a control/transmission station. Note that, the control/transmission station functions as both the control station and the transmission station. For ease of explanation, it is assumed in this example that the threshold value corresponding to the station number priority mode is 36 Mbps.

First, in the step (2)-01, through the reception station, the user requests a change (switching) of the operation mode of the control station into the station number priority mode (corresponding to the step Receiver-101 of FIG. 20). The user performs this step by, for example, selecting the station number priority mode through corresponding inputting means (e.g. push-button etc.).

Upon this request, in the step (2)-02, the reception station displays a message informing that the request for a change of the operation mode of the control station into the station number priority mode has been made to the control station (corresponding to the step Receiver-102 of FIG. 20). Then, in the step (2)-03, the reception station transmits an operation mode change request signal to the control/transmission station (corresponding to the step Receiver-103 of FIG. 20).

Upon reception of the mode change request signal in the step (2)-04 (corresponding to the step HC-101 of FIG. 19), the control/transmission station displays in the step (2)-05 a message informing that the request for changing the operation mode into the station number priority mode has been received from the reception station (corresponding to the step HC-102 of FIG. 19).

In the steps (2)-06 and (2)-07, the control/transmission station carries out judgment as to whether the change to the required operation mode is acceptable (allowable) or not. If it is judged that the request is acceptable, the control/transmission station changes the threshold value of the minimum transmission rate to 36 Mbps, according to the table, so as to renew a judgment standard (corresponding to the steps HC-103 and HC-104 of FIG. 19). By so setting, the control station will only accept a request of stream from a transmission station with the minimum transmission rate of 36 Mbps or greater (corresponding to the step HC-109 of FIG. 19).

Then, in the step (2)-08, the change of operation mode of the control station into the station number priority mode is displayed in the control/transmission station (corresponding to the step HC-105 of FIG. 19). Then, in the step (2)-09, the control/transmission station informs a reception station (Receiver) that the operation mode has been changed to the station number priority mode (corresponding to the step HC-106 of FIG. 19).

Upon reception of the notification of the change of setting into the station number priority mode from the control/transmission station in the step (2)-10 (corresponding to the step Receiver-104 of FIG. 20), the reception station displays in the step (2)-11 a message informing that the operation mode of the control station has been changed to the station number priority mode (corresponding to the step Receiver-105 of FIG. 20), and then further displays in the step (2)-12 a message informing that the control station operates in the station number priority mode (corresponding to the step Receiver-106 of FIG. 20).

Note that, the steps (2)-02, (2)-05, (2)-08 through (2)-12 are optional steps to provide displays enabling immediate recognition of the operation mode of the control station. Further, the foregoing example assumes the case of the station number priority mode. When these steps are adopted for the distance priority mode, the control station only accepts a request of stream from a transmission station with the minimum transmission rate of, for example, 12 Mbps or greater, with reference to the foregoing table.

[Setting of Station Number Priority Mode (3)]

Here, with reference to FIGS. 19, 22 and 23, the following describes still another specific example of setting the operation mode of the control station to the station number priority mode.

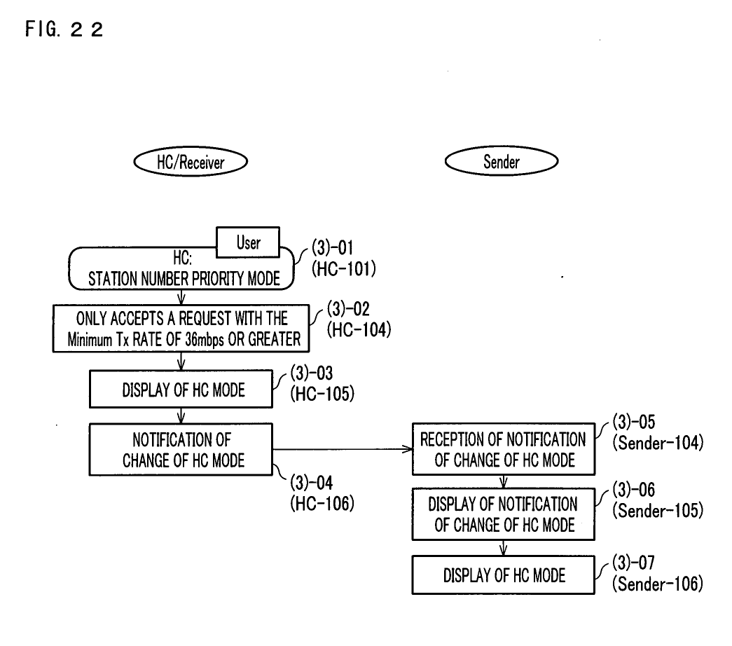

In the example of FIG. 22, the user makes setting of the station number priority mode for a control/transmission station (HC/Receiver). Note that, the control/transmission station functions as both the control station and the transmission station. For ease of explanation, it is assumed in this example that the threshold value corresponding to the station number priority mode is 36 Mbps.

First, in the step (3)-01, the user selects the station number priority mode as the operation mode of the control station (corresponding to the step HC-101 of FIG. 19). The user performs this step by, for example, selecting the station number priority mode through corresponding inputting means (e.g. push-button etc.).

Upon the selection through the inputting means, in the control/transmission station, the threshold of the minimum transmission rate is set to, for example, 36 Mbps with reference to the table (corresponding to the step HC-104 of FIG. 19). By so setting, the control/transmission station only accepts a request of stream from a transmission station with the minimum transmission rate of 36 Mbps or greater (Step (3)-02).

Then, in the step (3)-03, the change of operation mode of the control station into the station number priority mode is displayed in the control/transmission station (corresponding to the step HC-105 of FIG. 19). Then, in the step (3)-04, the control/transmission station informs a transmission station (Sender) that the operation mode of the control station has been changed to the station number priority mode.

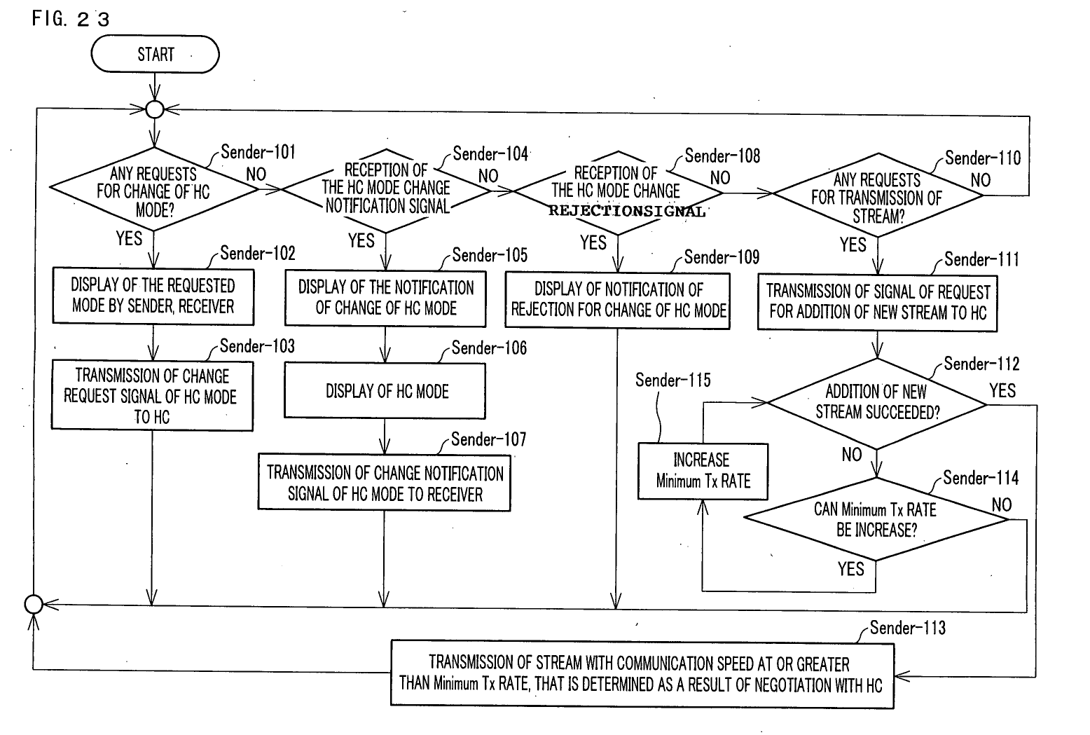

Upon reception of the notification of the change of setting into the station number priority mode from the control/transmission station in the step (3)-05 (corresponding to the step Sender-104 of FIG. 23), the transmission station displays in the step (3)-06 a message informing that the operation mode of the control station has been changed to the station number priority mode (corresponding to the step Sender-105 of FIG. 23), and then further displays in the step (3)-07 a message informing that the control station operates in the station number priority mode (corresponding to the step Sender-106 of FIG. 23).

Note that, the steps (3)-03 through (3)-07 are optional steps to provide displays enabling immediate recognition of the operation mode of the control station. Further, the foregoing example assumes the case of the station number priority mode. When these steps are adopted for the distance priority mode, the control station only accepts a request of stream from a transmission station with the minimum transmission rate of, for example, 12 Mbps or greater, with reference to the foregoing table.

[Setting of Station Number Priority Mode (4)]

Here, with reference to FIGS. 19, 23 and 24, the following describes yet another specific example of setting the operation mode of the control station to the station number priority mode.

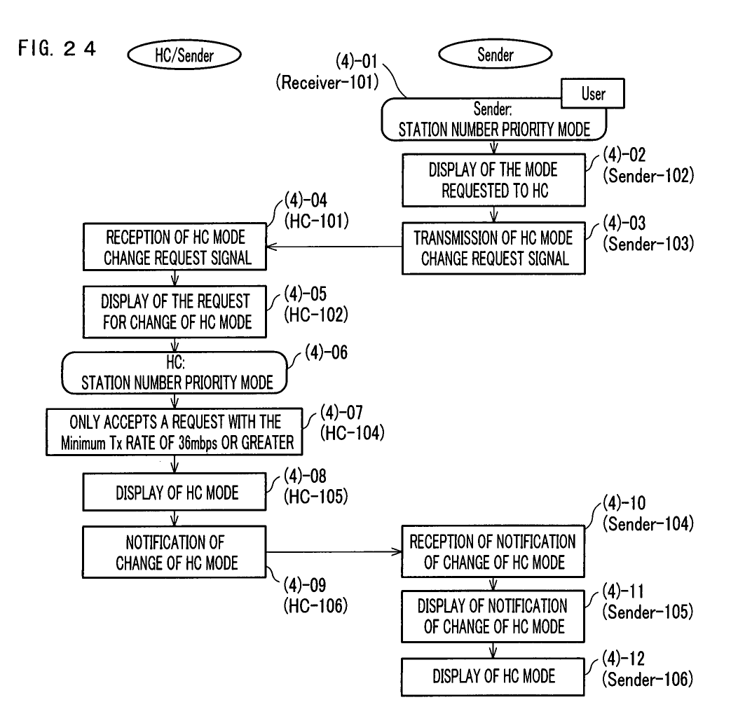

In the example of FIG. 24, the user specifies the station number priority mode for the operation mode of the control station, via a transmission station (at the transmission station), and then transmits a mode change request signal to a control/transmission station. Note that, the control/transmission station functions as both the control station and the transmission station. For ease of explanation, it is assumed in this example that the threshold value corresponding to the station number priority mode is 36 Mbps.

First, in the step (4)-01, through the transmission station, the user requests a change (switching) of the operation mode of the control station into the station number priority mode (corresponding to the step Sender-101 of FIG. 23). The user performs this step by, for example, selecting the station number priority mode through corresponding inputting means (e.g. push-button etc.).

Upon this request, in the step (4)-02, the transmission station displays a message informing that the request for a change of the operation mode of the control station into the station number priority mode has been made to the control station (corresponding to the step Sender-102 of FIG. 23). Then, in the step (4)-03, the transmission station transmits an operation mode change request signal to the control/transmission station (corresponding to the step Sender-103 of FIG. 23).

Upon reception of the mode change request signal in the step (4)-04 (corresponding to the step HC-101 of FIG. 19), the control/transmission station displays in the step (4)-05 a message informing that the request for changing the operation mode into the station number priority mode has been received from the transmission station (corresponding to the step HC-102 of FIG. 19).

In the steps (4)-06 and (4)-07, the control/transmission station carries out judgment as to whether the change to the required operation mode is acceptable (allowable) or not. If it is judged that the request is acceptable, the control/transmission station changes the threshold value of the minimum transmission rate to 36 Mbps, according to the table, so as to renew a judgment standard (corresponding to the steps HC-103 and HC-104 of FIG. 19). By so setting, the control station will only accept a request of stream from a transmission station with the minimum transmission rate of 36 Mbps or greater (corresponding to the step HC-109 of FIG. 19).

Then, in the step (4)-08, the change of operation mode of the control station into the station number priority mode is displayed in the control/transmission station (corresponding to the step HC-105 of FIG. 19). Then, in the step (4)-09, the control/transmission station informs a transmission station (Sender) that the operation mode has been changed to the station number priority mode (corresponding to the step HC-106 of FIG. 19).

Upon reception of the notification of the change of setting into the station number priority mode from the control/transmission station in the step (4)-10 (corresponding to the step Sender-104 of FIG. 23), the transmission station displays in the step (4)-11 a message informing that the operation mode of the control station has been changed to the station number priority mode (corresponding to the step Sender-105 of FIG. 23), and then further displays in the step (4)-12 a message informing that the control station operates in the station number priority mode (corresponding to the step Sender-106 of FIG. 23).

Note that, the steps (4)-02, (4)-05, (2)-08 through (4)-12 are optional steps to provide displays enabling immediate recognition of the operation mode of the control station. Further, the foregoing example assumes the case of the station number priority mode. When these steps are adopted for the distance priority mode, the control station only accepts a request of stream from a transmission station with the minimum transmission rate of, for example, 12 Mbps or greater, with reference to the foregoing table.

[Setting of Station Number Priority Mode (5)]

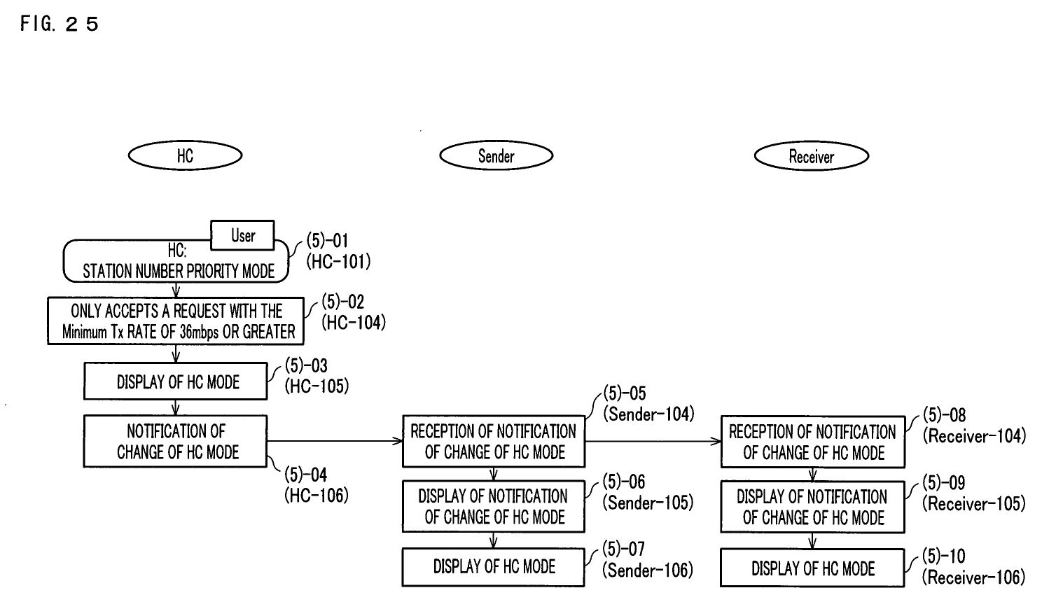

Here, with reference to FIGS. 19, 20, 23 and 25, the following describes still another specific example of setting the operation mode of the control station to the station number priority mode. In the example of FIG. 25, the user make setting of the station number priority mode for the operation mode of the control station, at a control station. Note that, for ease of explanation, it is assumed in this example that the threshold value corresponding to the station number priority mode is 36 Mbps.

First, in the step (5)-01, the operation mode of the control station is set to the station number priority mode by the user (corresponding to the step HC-101 of FIG. 19). The user performs this step by, for example, selecting the station number priority mode through corresponding inputting means (e.g. push-button etc.).

Upon the selection through the inputting means, in the control station, the threshold of the minimum transmission rate is set to, for example, 36 Mbps with reference to the table (corresponding to the step HC-104 of FIG. 19). By so setting, the control station only accepts a request of stream from a transmission station with the minimum transmission rate of 36 Mbps or greater (Step (5)-02).

Then, in the step (5)-03, the change of operation mode of the control station into the station number priority mode is displayed in the control station (corresponding to the step HC-105 of FIG. 19). Then, in the step (5)-04, the control/transmission station informs a transmission station (Sender) that the operation mode of the control station has been changed to the station number priority mode (corresponding to the step HC-106 of FIG. 19).

Upon reception of the notification of the change of setting into the station number priority mode from the control station in the step (5)-05 (corresponding to the step Sender-104 of FIG. 23), the transmission station displays in the step (5)-06 a message informing that the notification of change of operation mode into the station number priority mode has been received from the control station (corresponding to the step Sender-105 of FIG. 23), and then further displays the new (updated) operation mode (station number priority mode) of the control station (corresponding to the step Sender-106 of FIG. 23).

Upon reception of the notification of the change of setting from the control station in the step (5)-05 (corresponding to the step Sender-104 of FIG. 23), the transmission station transmits to a reception station notification of the change of setting of the operation mode of the control station into the station number priority. Upon reception of the notification in the step (5)-08 (corresponding to the step Receiver-104 of FIG. 20), the reception station displays in the step (5)-09 a message informing that the operation mode of the control station has been changed to the station number priority mode (corresponding to the step Receiver-105 of FIG. 20), and then further displays in the step (5)-10 the new (updated) operation mode (station number priority mode) of the control station (corresponding to the step Receiver-106 of FIG. 20).

Note that, the steps (5)-03 through (5)-10 are optional steps to provide displays enabling immediate recognition of the operation mode of the control station. Further, the foregoing example assumes the case of the station number priority mode. When these steps are adopted for the distance priority mode, the control station only accepts a request of stream from a transmission station with the minimum transmission rate of, for example, 12 Mbps or greater, with reference to the foregoing table.

[Setting of station number priority mode (6)]Here, with reference to FIGS. 19, 20, 23 and 26, the following describes yet another specific example of setting the operation mode of the control station to the station number priority mode.

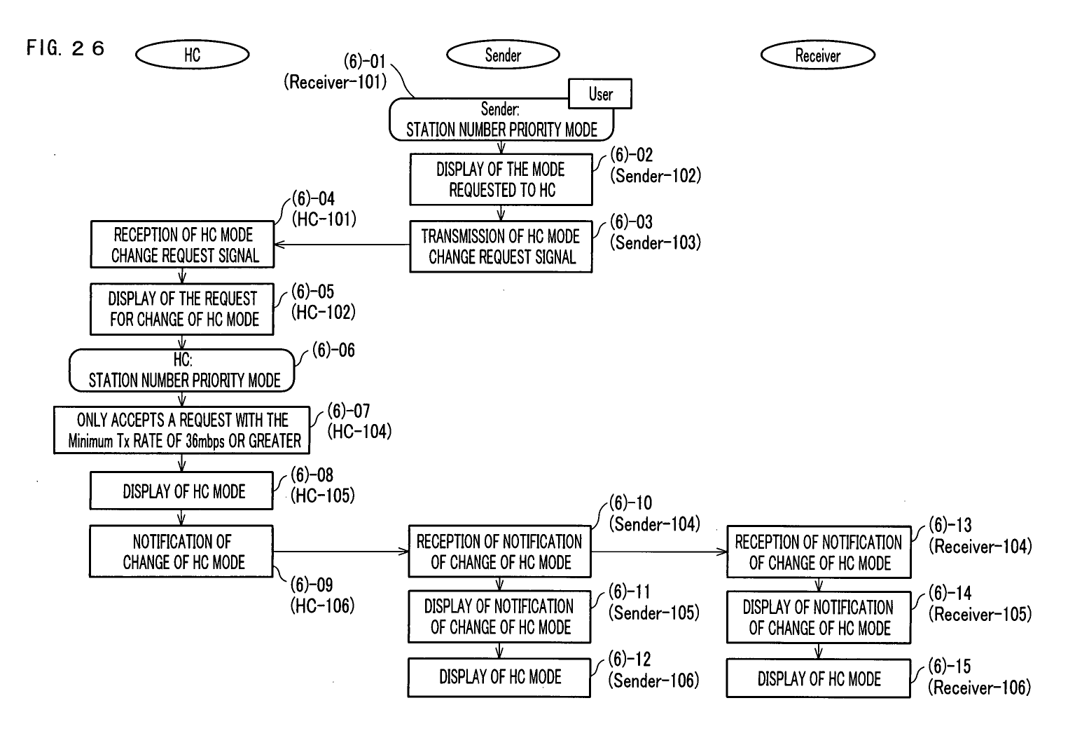

In the example of FIG. 26, the user specifies the station number priority mode for the operation mode of the control station, at the transmission station, and then transmits a mode change request signal to a control station. Note that, for ease of explanation, it is assumed in this example that the threshold value corresponding to the station number priority mode is 36 Mbps.

First, in the step (6)-01, through the transmission station (at the transmission station), the user requests a change (switching) of the operation mode of the control station into the station number priority mode (corresponding to the step Sender-101 of FIG. 23). The user performs this step by, for example, selecting the station number priority mode through corresponding inputting means (e.g. push-button etc.).

Upon this request, in the step (6)-02, the transmission station displays a message informing that the request for a change of the operation mode of the control station into the station number priority mode has been made to the control station (corresponding to the step Sender-102 of FIG. 23). Then, in the step (6)-03, the transmission station transmits an operation mode change request signal to the control station (corresponding to the step Sender-103 of FIG. 23).

Upon reception of the mode change request signal in the step (6)-04 (corresponding to the step HC-101 of FIG. 19), the control station displays in the step (6)-05 a message informing that the request for changing the operation mode into the station number priority mode has been received from the transmission station (corresponding to the step HC-102 of FIG. 19).

In the steps (6)-06 and (6)-07, the control station carries out judgment as to whether the change to the required operation mode is acceptable (allowable) or not. If it is judged that the request is acceptable, the control station changes the threshold value of the minimum transmission rate to 36 Mbps, according to the table, so as to renew a judgment standard (corresponding to the steps HC-103 and HC-104 of FIG. 19). By so setting, the control station will only accept a request of stream from a transmission station with the minimum transmission rate of 36 Mbps or greater (corresponding to the step HC-109 of FIG. 19).

Then, in the step (6)-08, the change (switching) of operation mode of the control station into the station number priority mode is displayed in the control station (corresponding to the step HC-105 of FIG. 19). Then, in the step (6)-09, the control station informs a transmission station (Sender) that the operation mode has been changed to the station number priority mode (corresponding to the step HC-106 of FIG. 19).

Upon reception of the notification of the change of setting into the station number priority mode from the control station in the step (6)-10 (corresponding to the step Sender-104 of FIG. 23), the transmission station displays in the step (6)-11 the received notification (a message informing that the operation mode of the control station has been changed to the station number priority mode) (corresponding to the step Sender-105 of FIG. 23), and then further displays in the step (6)-12 a message informing that the control station operates in the station number priority mode (corresponding to the step Sender-106 of FIG. 23).

Upon reception of the notification of the change of setting from the control station in the step (6)-10 (corresponding to the step Sender-104 of FIG. 23), the transmission station transmits to a reception station notification of the change of setting of the operation mode of the control station into the station number priority. Upon reception of the notification in the step (6)-13 (corresponding to the step Receiver-104 of FIG. 20), the reception station displays in the step (6)-14 a message informing that the operation mode of the control station has been changed to the station number priority mode (corresponding to the step Receiver-105 of FIG. 20), and then further displays in the step (6)-15 the new (updated) operation mode (station number priority mode) of the control station (corresponding to the step Receiver-106 of FIG. 20).

Note that, the steps (6)-02, (6)-05, (6)-08 through (6)-15 are optional steps to provide displays enabling immediate recognition of the operation mode of the control station. Further, the foregoing example assumes the case of the station number priority mode. When these steps are adopted for the distance priority mode, the control station only accepts a request of stream from a transmission station with the minimum transmission rate of, for example, 12 Mbps or greater, with reference to the foregoing table.

[Setting of Station Number Priority Mode (7)]

Here, with reference to FIGS. 19, 20, 23 and 27, the following describes still another specific example of setting the operation mode of the control station to the station number priority mode.

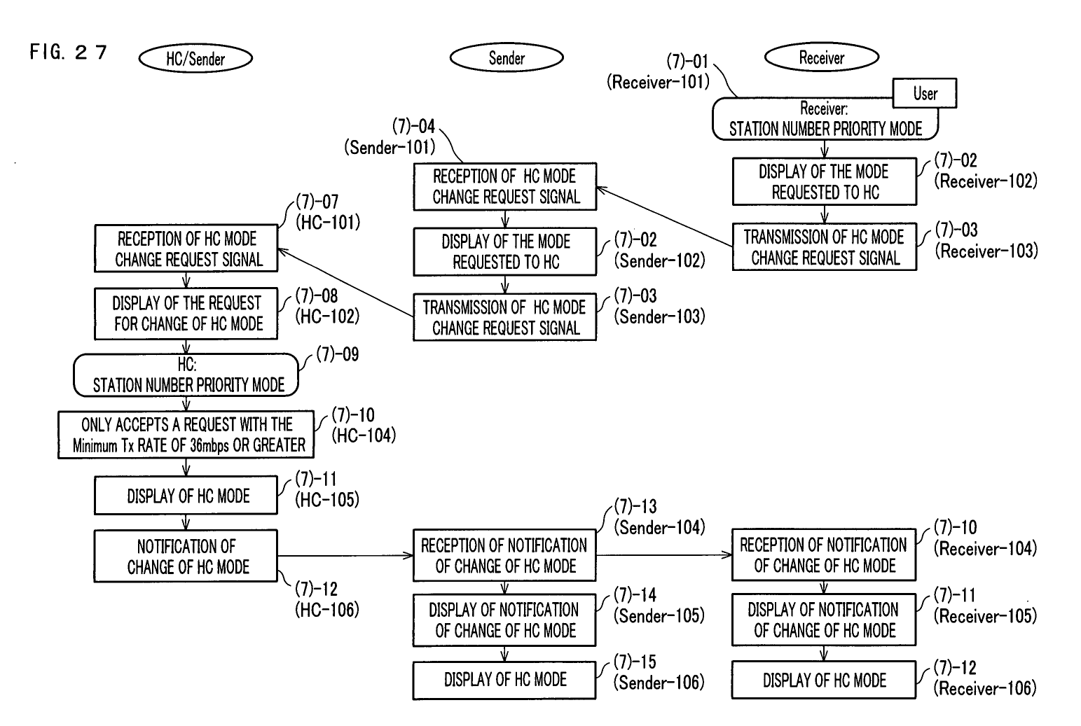

In the example of FIG. 27, the user specifies the station number priority mode for the operation mode of the control station, at the reception station (Receiver), and then transmits a mode change request signal to a transmission station. Upon reception of the mode change request signal, the transmission station transmits the received signal further to a control station. Note that, for ease of explanation, it is assumed in this example that the threshold value corresponding to the station number priority mode is 36 Mbps.

First, in the step (7)-01, through the reception station (at the reception station), the user requests a change (switching) of the operation mode of the control station into the station number priority mode (corresponding to the step Receiver-101 of FIG. 20). The user performs this step by, for example, selecting the station number priority mode through corresponding inputting means (e.g. push-button etc.).

Upon this request, in the step (7)-02, the reception station displays a message informing that the request for a change of the operation mode of the control station into the station number priority mode has been made to the control station (corresponding to the step Receiver-102 of FIG. 20). Then, in the step (7)-03, the reception station transmits an operation mode change request signal to the transmission station (corresponding to the step Receiver-103 of FIG. 20).

Upon reception of the mode change request in the step (7)-04 (corresponding to the step Sender-101 of FIG. 23), the transmission station displays in the step (7)-05 a message informing that the request for changing the operation mode into the station number priority mode has been received from the reception station (corresponding to the step Sender-102 of FIG. 23). In the step (7)-06, the transmission station transmits to the control station notification of reception of the request for changing the operation mode from the reception station (corresponding to the step Sender-103 of FIG. 23).

Upon reception of the mode change request in the step (7)-07 (corresponding to the step HC-101 of FIG. 19), the control/transmission station displays in the step (7)-08 a message informing that the request for changing the operation mode into the station number priority mode has been received from the reception station (corresponding to the step HC-102 of FIG. 19).

In the steps (7)-09 and (7)-10, the control station carries out judgment as to whether the change to the required operation mode is acceptable (allowable) or not. If it is judged that the request is acceptable, the control station changes the threshold value of the minimum transmission rate to 36 Mbps, according to the table, so as to renew a judgment standard (corresponding to the steps HC-103 and HC-104 of FIG. 19). By so setting, the control station will only accept a request of stream from a transmission station with the minimum transmission rate of 36 Mbps or greater (corresponding to the step HC-109 of FIG. 19).

Then, in the step (7)-11, the change of operation mode of the control station into the station number priority mode is displayed in the control station (corresponding to the step HC-105 of FIG. 19). Then, in the step (7)-12, the control station informs a transmission station (Sender) that the operation mode has been changed to the station number priority mode (corresponding to the step HC-106 of FIG. 19).

Upon reception of the notification of the change of setting into the station number priority mode from the control station in the step (7)-13 (corresponding to the step Sender-104 of FIG. 23), the reception station displays in the step (7)-14 the received notification (a message informing that the operation mode of the control station has been changed to the station number priority mode) (corresponding to the step Sender-105 of FIG. 23), and then further displays in the step (7)-15 a message informing that the control station operates in the station number priority mode (corresponding to the step Sender-106 of FIG. 23).

Upon reception of the notification of the change of setting from the control station in the step (7)-13 (corresponding to the step Sender-104 of FIG. 23), the transmission station transmits to a reception station notification of the change of setting of the operation mode into the station number priority. Upon reception of the notification in the step (7)-16 (corresponding to the step Receiver-104 of FIG. 20), the reception station displays in the step (7)-17 a message informing that the operation mode of the control station has been changed to the station number priority mode (corresponding to the step Receiver-105 of FIG. 20), and then further displays in the step (7)-18 the new (updated) operation mode (station number priority mode) of the control station (corresponding to the step Receiver-106 of FIG. 20).

Note that, the steps (7)-02, (7)-05, (7)-08, and (7)-11 through (7)-18 are optional steps to provide displays enabling immediate recognition of the operation mode of the control station. Further, the foregoing example assumes the case of the station number priority mode. When these steps are adopted for the distance priority mode, the control station only accepts a request of stream from a transmission station with the minimum transmission rate of, for example, 12 Mbps or greater, with reference to the foregoing table.

[Flow Chart for Setting of Station Number Priority Mode (1)]

FIGS. 19, 20 and 23 show flow charts of the described steps (1) through (7) of FIG. 17, in terms of the control station, the reception station, and the transmission station, respectively.

As shown in FIG. 19, when the control station cannot accept the request for a change of the operation mode (the threshold value of the minimum transmission rate) in the step HC-103, the sequence goes to the step HC-107 to transmit a change rejection signal as notification and/or reason for rejection of the request for a change of the control station. The change rejection signal is transmitted to the transmission station or the reception station that made the request. This allows the user to take a necessary action.

When there is no request for a change of the operation mode of the control station, the sequence goes to the step HC-108 to carry out judgment as to whether or not a request for addition of new stream or a request for a change of stream has been made from the transmission station. When it is judged that the request has been made, another judgment as to whether or not the minimum transmission rate is equal to or greater than the determined threshold value is carried out (step HC-109).

If the minimum transmission rate is equal to or greater than the threshold value, the control station determines that the request for addition of new stream or the request for a change of stream is acceptable; on the other hand, if the minimum transmission rate is lower than the threshold value, the control station determines that such a request is not acceptable (step HC-110). When it is judged that the request is acceptable, the control station guarantees provision of TXOP allowing transmission with the minimum transmission rate (step HC-111). On the other hand, when it is judged that the request is not acceptable, the request is rejected (step HC-112).

As shown in FIG. 23, when the control station accepts the request for a change of the operation mode, as described, the transmission station receives the change notification signal from the control station (step Sender-104), and then transmits the change notification signal to the reception station (step Sender-107) after the steps Sender-105 and Sender-106 are carried out.

On the other hand, when the control station cannot accept the request for a change of the operation mode, the transmission station receives a change rejection signal from the control station (step Sender-108) and displays the notification (from the control station) and/or reason for rejection of the request for a change of the control station (step Sender-109). This allows the user to take a necessary action.

When there is no request for a change of the operation mode of the control station, the sequence goes to the step Sender-110. When a request for addition of new stream has been made, the transmission station transmits a notification signal (new stream addition request signal) to the control station (step Sender-111). Then, when the control station accepts the request for addition of new stream, the transmission station carries out transmission of the stream with respect to the control station, with a communication speed of at or greater than the minimum transmission rate that has been determined as a result of negotiation with the control station (step Sender-113).

On the other hand, when the control station cannot accept the request for addition of new stream, judgment is carried out as to whether or not the minimum transmission rate can be increased (set the minimum transmission rate to a higher value) (step Sender-114). When it is judged that the increase is possible, the minimum transmission rate is increased (step Sender-115), and then the sequence goes to the step Sender-112 to repeat the process.

Further, as shown in FIG. 20, when the control station accepts the request for a change of the operation mode, as described, the reception station receives the change notification signal from the transmission station (step Receiver-104), and carries out the steps Receiver-105 and Receiver-106.

On the other hand, when the control station cannot accept the request for a change of the operation mode, the reception station receives a change rejection signal from the transmission station (step Receiver-107) and displays the notification (from the control station) and/or reason for rejection of the request for a change of the control station (step Receiver-108). This allows the user to take a necessary action.

[Mode Selecting Operation]

As explained, the threshold value, that is used as a judgment standard as to whether or not the minimum transmission rate is acceptable or not, can be set anytime according to the desired usage of the user, through input means, such as a push-button, or transmission/reception of a signal, by the user or making a request for a change of the operation mode. Further, such a setting can be performed at the control station, the transmission station or the reception station. In this case, the control station operates in the station number priority mode when the threshold is set to a high value, and operates in the distance priority mode when the threshold is set to a low value.

With one of the foregoing methods (1), (3) and (5) for changing the operation mode of the control station (HC), a user, for example, who wants to use three SDTVs, makes the request for a change of the operation mode with respect to the control station, so that the control station sets the threshold of the minimum transmission rate to 36 Mbps according to the foregoing table (otherwise, the user may input the request for a change to the station number priority mode with a corresponding push-button etc.). As a result, the operation mode of the control station is changed to the station number priority mode.

Further, with one of the foregoing methods (4), (6), a user, for example, who wants to use three SDTVs, makes the request for a change of the operation mode through the transmission station, (or may input the request for a change of the operation mode into the station number priority mode with a corresponding push-button etc.). Upon reception of the request, the control station carries out judgment as to whether the threshold value of the minimum transmission rate is changeable or not. When it is acceptable, the control station sets the threshold of the minimum transmission rate to 36 Mbps according to the foregoing table and transmits a change accept signal to the transmission station. When the request for the change of the operation mode (request for a change of the threshold value of the minimum transmission rate) is not acceptable, the control station transmits a change rejection signal to the transmission station. In this way, the operation mode of the control station may be changed into the station number priority mode through the transmission station.

Meanwhile, when the user wants to use a single SDTV with high picture quality, he/she is allowed to change the threshold of the minimum transmission rate at the control station to 12 Mbps by inputting a request for the distance priority mode with a corresponding push-button etc. As a result, as with the case of the station number priority mode, the operation mode of the control station is changed to the distance priority mode, if acceptable.

Further, with the method (2) or (7), the change of operation mode of the control station may also be carried out through a reception station (via the transmission station in the case of (7)).

With the described arrangement, the present invention provides a communication management system with significantly superior operationality.

[Another Specific Example of Handling Fluctuation of Physical Rate]

Here, the following minutely explains another specific example to cope with an automatic change of the transmission PHY rate at the application layer of transmission station.

This structure allows setting of the minimum transmission rate (minimum Tx rate), that is the minimum value of the transmission PHY rate of the transmission station, at the transmission station (Sender), thus allowing the user to set the minimum transmission rate to an appropriate value for the desired usage.

Further, the transmission station may use a high minimum transmission rate when performing high-speed transmission. This condition is hereinafter referred to as a high-speed transmission mode. On the other hand, the transmission station may use a low minimum transmission rate when performing low-speed transmission. This condition is hereinafter referred to as a low-speed transmission mode.

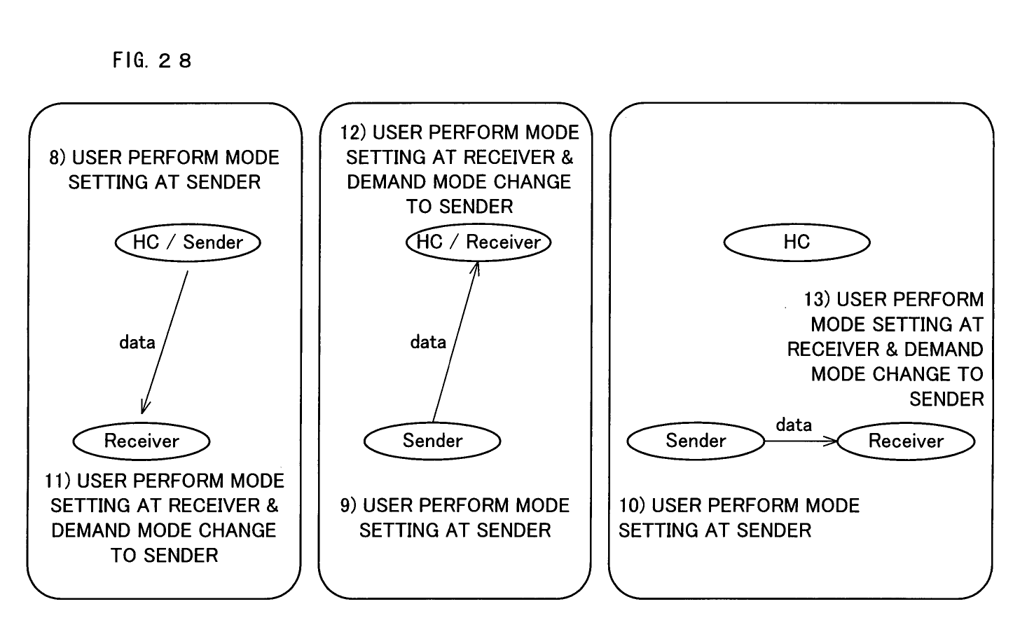

As shown in FIG. 28, at least 6 ((8) through (13)) patterns can be assumed for the foregoing structure. The (8) through (13) patterns may respectively have optional arrangements, such as display of the mode of transmission station, or display of notification of change (switching) of the mode of transmission station. Note that, in the following explanation, the steps (8) through (13) in the respective drawings correspond to the patterns (8) through (13) of FIG. 28.

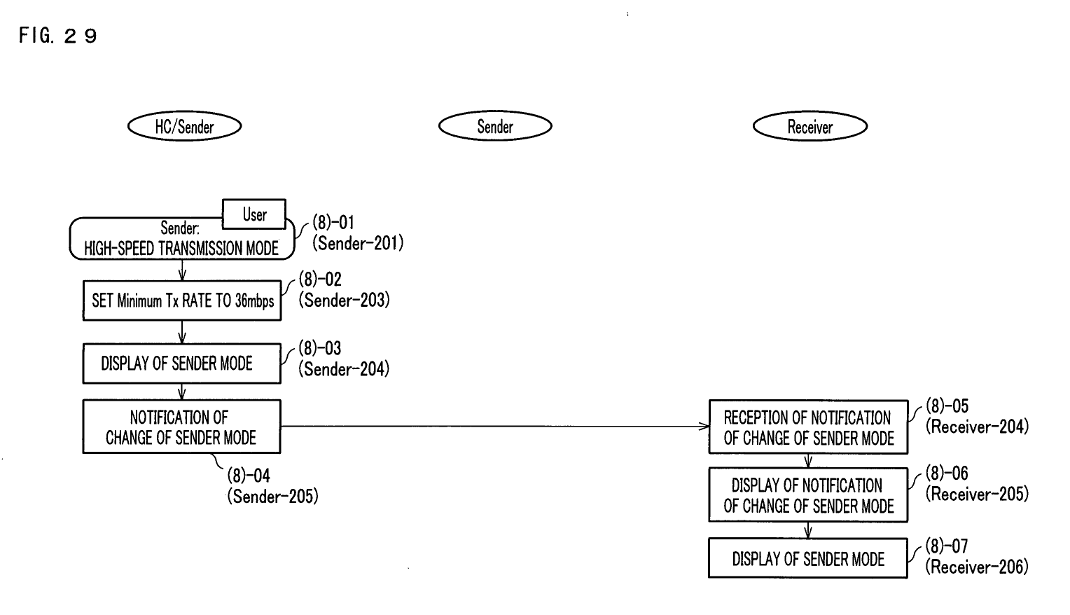

Here, with reference to FIGS. 29 through 31, the following describes a specific example of the structure in which the user sets the minimum transmission rate, that is the minimum value of the transmission PHY rate of the transmission station, to an appropriate value for the desired usage (specific method for setting one of the high-speed transmission mode and the low-speed transmission mode).

[Setting of High-Speed Transmission Mode (1)]

FIG. 29 shows an example where the user makes setting of the high-speed transmission mode for a control/transmission station (HC/Sender). Note that, the control/transmission station functions as both the control station and the transmission station. For ease of explanation, it is assumed in this example that the minimum transmission rate corresponding to the high-speed transmission mode is 36 Mbps.

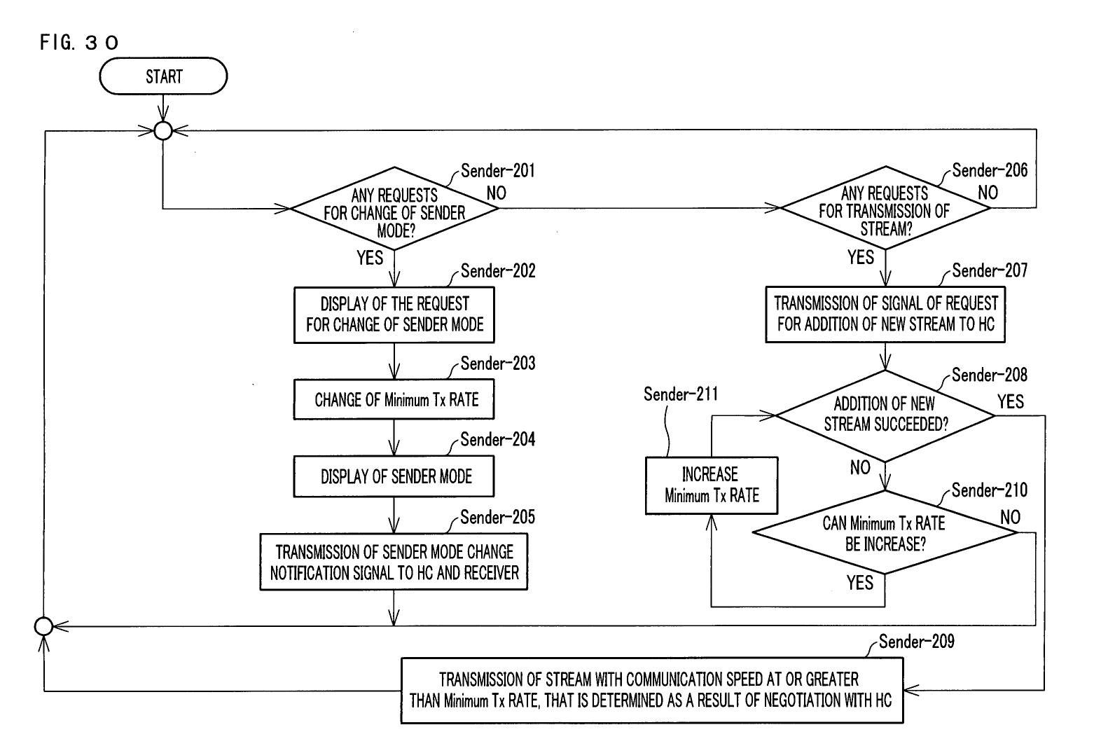

First, in the step (8)-01, the operation mode of the transmission station is set to the high-speed transmission mode by the user (corresponding to the step Sender-201 of FIG. 30). The user performs this step by, for example, selecting the high-speed transmission mode through corresponding inputting means (e.g. push-button etc.).

Upon the selection through the inputting means, the control/transmission station displays the request for a change to the high-speed transmission mode (see the step Sender-202 of FIG. 30), and sets the minimum transmission rate to 36 Mbps in the step (8)-02 (corresponding to the step Sender-203 of FIG. 30). Then, in the step (8)-03, the control/transmission station displays the new (updated) operation mode (high-speed transmission mode) (corresponding to the step Sender-204 of FIG. 30). Then, in the step (8)-04, the control/transmission station informs a reception station (Receiver) that the operation mode has been changed to the high-speed transmission mode (corresponding to the step Sender-205 of FIG. 30).

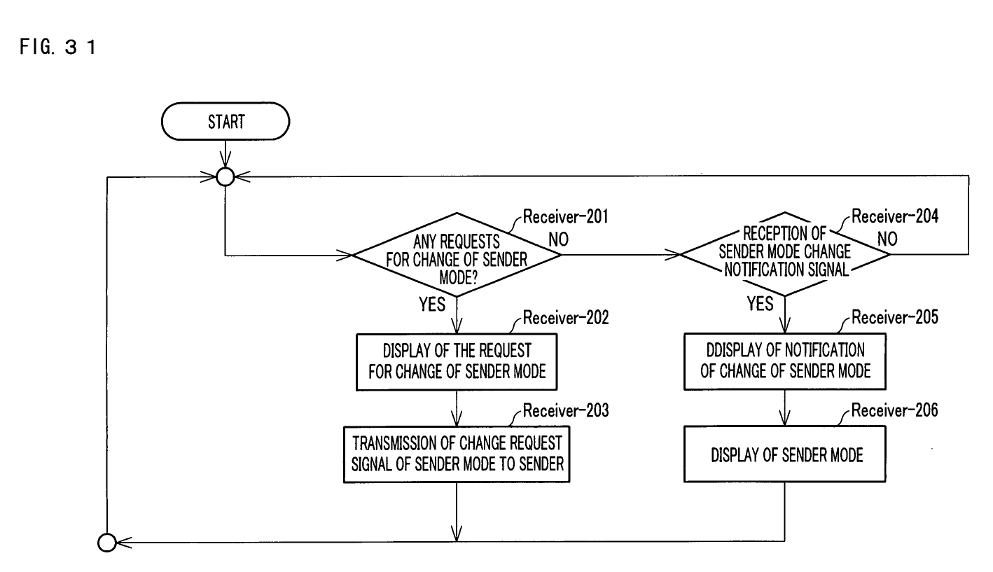

Upon reception of the notification of the change to the high-speed transmission mode from the control/transmission station in the step (8)-05 (corresponding to the step Receiver-204 of FIG. 31), the reception station displays in the step (8)-06 a message informing that the operation mode of the transmission station has been changed to the high-speed transmission mode (corresponding to the step Receiver-205 of FIG. 31), and then further displays in the step (8)-07 a message informing that the transmission station operates in the high-speed transmission mode (corresponding to the step Receiver-206 of FIG. 31).

Note that, the steps (8)-03 through (8)-07 are optional steps to provide displays enabling immediate recognition of the operation mode of the transmission station (control/transmission station). Further, in the foregoing example, the steps (8)-01 and (8)-02 assume the case of the high-speed transmission mode. When these steps are adopted for the low-speed transmission mode, the minimum transmission rate is set to 12 Mbps, for example.

[Setting of High-Speed Transmission Mode (2)]

Here, with reference to FIGS. 30 through 32, the following describes another specific example of the structure in which the user sets the minimum transmission rate, that is the minimum value of the transmission PHY rate of the transmission station, to an appropriate value for the desired usage.

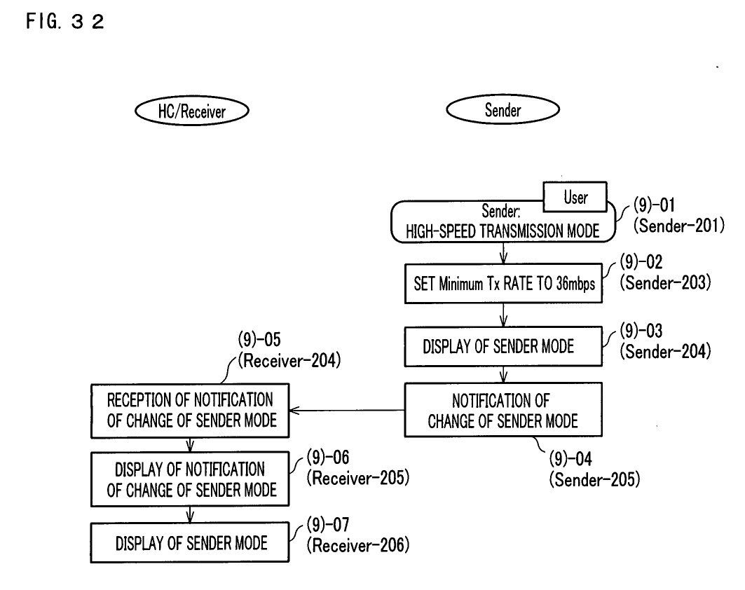

FIG. 32 shows an example where the user makes setting of the high-speed transmission mode for a transmission station (Sender). Note that, the control/reception station (HC/Receiver) functions as both the control station and the reception station. For ease of explanation, it is assumed in this example that the minimum transmission rate corresponding to the high-speed transmission mode is 36 Mbps.

First, in the step (9)-01, the operation mode of the transmission station is set to the high-speed transmission mode by the user (corresponding to the step Sender-201 of FIG. 30). The user performs this step by, for example, selecting the high-speed transmission mode through corresponding inputting means (e.g. push-button etc.).

Upon the selection through the inputting means, the transmission station displays the request for a change to the high-speed transmission mode (see the step Sender-202 of FIG. 30), and sets the minimum transmission rate to 36 Mbps in the step (9)-02 (corresponding to the step Sender-203 of FIG. 30).

Then, in the step (9)-03, the transmission station displays the new (updated) operation mode (high-speed transmission mode) (corresponding to the step Sender-204 of FIG. 30). Further, in the step (9)-04, the transmission station informs a control/reception station that the operation mode has been changed to the high-speed transmission mode (corresponding to the step Sender-205 of FIG. 30).

Upon reception of the notification of the change to the high-speed transmission mode from the transmission station in the step (9)-05 (corresponding to the step Receiver-204 of FIG. 31), the control/reception station displays in the step (9)-06 a message informing that the operation mode of the transmission station has been changed to the high-speed transmission mode (corresponding to the step Receiver-205 of FIG. 31), and then further displays in the step (9)-07 a message informing that the transmission station operates in the high-speed transmission mode (corresponding to the step Receiver-206 of FIG. 31).

Note that, the steps (9)-03 through (9)-07 are optional steps to provide displays enabling immediate recognition of the operation mode of the transmission station. Further, the foregoing example assumes the case of the high-speed transmission mode. In the low-speed transmission mode, the minimum transmission rate is set to 12 Mbps, for example.

[Setting of High-Speed Transmission Mode (3)]

Here, with reference to FIGS. 30, 31, 33 and 34, the following describes still another specific example of the structure in which the user sets the minimum transmission rate, that is the minimum value of the transmission PHY rate of the transmission station, to an appropriate value for the desired usage.

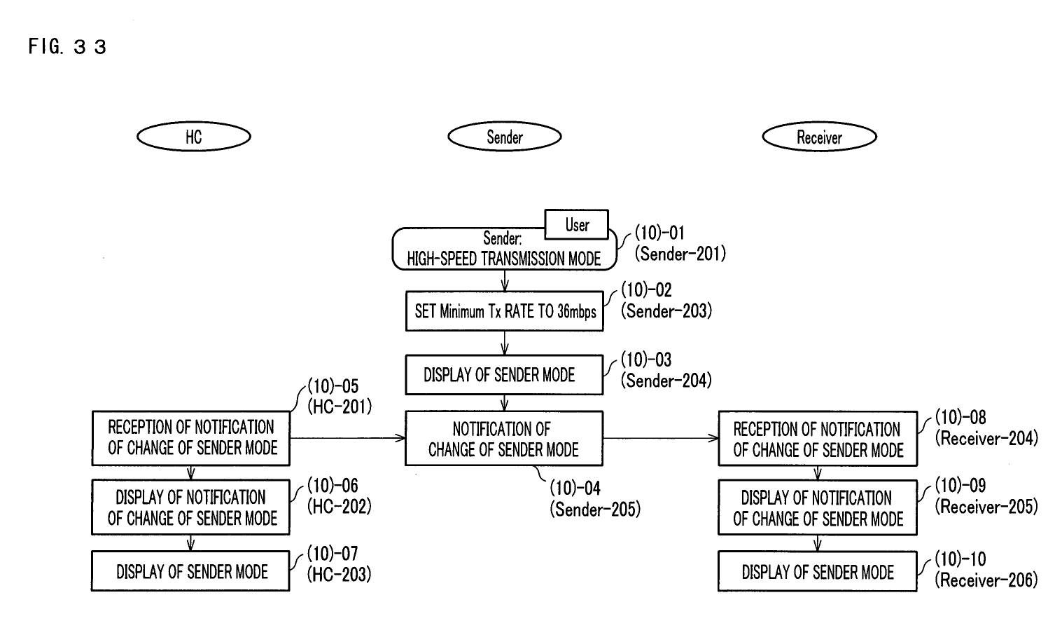

FIG. 33 shows an example where the user makes setting of the high-speed transmission mode for a transmission station (Sender). Note that, for ease of explanation, it is assumed in this example that the minimum transmission rate corresponding to the high-speed transmission mode is 36 Mbps.

First, in the step (10)-01, the operation mode of the transmission station is set to the high-speed transmission mode by the user (corresponding to the step Sender-201 of FIG. 30). The user performs this step by, for example, selecting the high-speed transmission mode through corresponding inputting means (e.g. push-button etc.).

Upon the selection through the inputting means, the transmission station displays the request for a change to the high-speed transmission mode (see the step Sender-202 of FIG. 30), and sets the minimum transmission rate to 36 Mbps in the step (10)-02 (corresponding to the step Sender-203 of FIG. 30).

Then, in the step (10)-03, the transmission station displays the new (updated) operation mode (high-speed transmission mode) (corresponding to the step Sender-204 of FIG. 30). Then, in the step (10)-04, the transmission station separately informs the control station and the reception station that the operation mode has been changed to the high-speed transmission mode (corresponding to the step Sender-205 of FIG. 30).

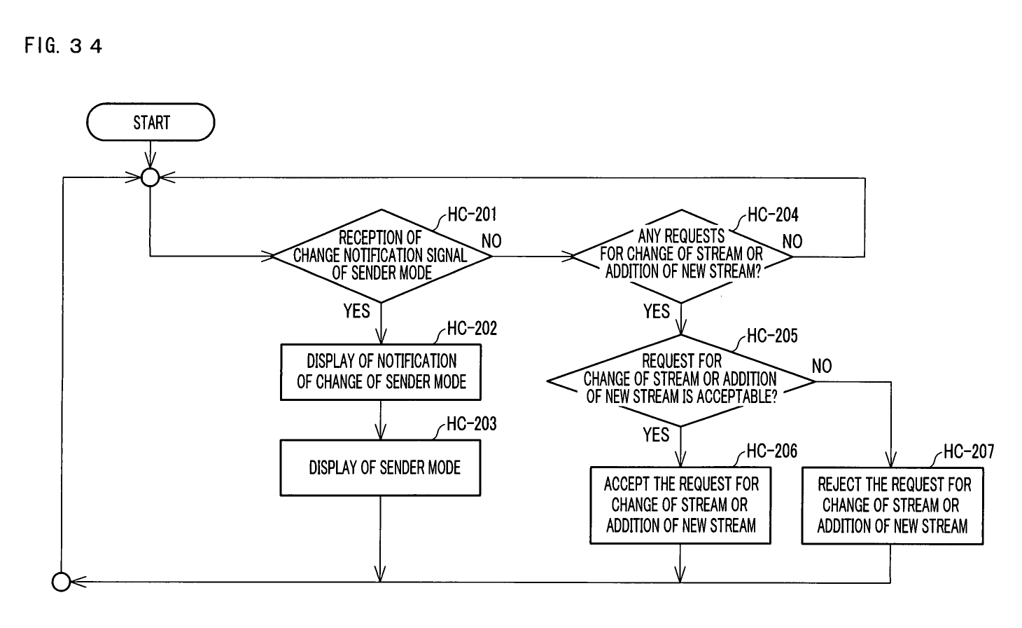

Upon reception of the notification of the change to the high-speed transmission mode from the transmission station in the step (10)-05 (corresponding to the step HC-201 of FIG. 34), the control station displays in the step (10)-06 a message informing that the operation mode of the transmission station has been changed to the high-speed transmission mode (corresponding to the step HC-202 of FIG. 34), and then further displays in the step (10)-07 a message informing that the transmission station operates in the high-speed transmission mode (corresponding to the step HC-203 of FIG. 34).

Meanwhile, upon reception of the notification of the change to the high-speed transmission mode from the transmission station in the step (10)-08 (corresponding to the step Receiver-204 of FIG. 31), the reception station displays in the step (10)-09 a message informing that the operation mode of the transmission station has been changed to the high-speed transmission mode (corresponding to the step Receiver-205 of FIG. 31), and then further displays in the step (10)-10 a message informing that the transmission station operates in the high-speed transmission mode (corresponding to the step Receiver-206 of FIG. 31).

Note that, the steps (10)-03 through (9)-10 are optional steps to provide displays enabling immediate recognition of the operation mode of the transmission station. Further, the foregoing example assumes the case of the high-speed transmission mode. In the low-speed transmission mode, the minimum transmission rate is set to 12 Mbps, for example.

[Setting of High-Speed Transmission Mode (4)]

Here, with reference to FIGS. 30, 31 and 35, the following describes yet another specific example of the structure in which the user sets the minimum transmission rate, that is the minimum value of the transmission PHY rate of the transmission station, to an appropriate value for the desired usage.

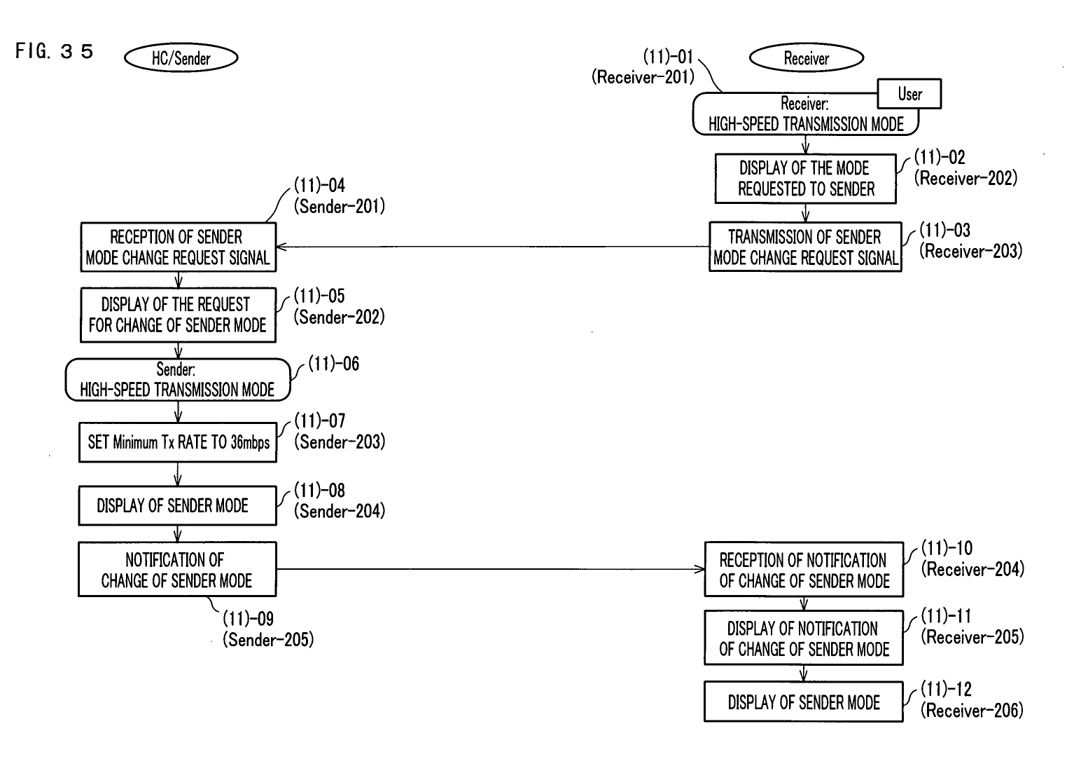

FIG. 35 shows an example where the user makes setting of the high-speed transmission mode for a control/transmission station (HC/Sender) via a reception station (Receiver) (at the reception station), and transmits an operation mode change request signal to the control/transmission station. Note that, the control/transmission station functions as both the control station and the transmission station. For ease of explanation, it is assumed in this example that the minimum transmission rate corresponding to the high-speed transmission mode is 36 Mbps.

First, in the step (11)-01, the user makes a request for a change of the operation mode of the transmission station to the high-speed transmission mode, via the reception station (at the reception station) (corresponding to the step Receiver-201 of FIG. 31). The user performs this step by, for example, selecting the high-speed transmission mode through corresponding inputting means (e.g. push-button etc.).

Upon the selection through the inputting means, in the step (11)-02, the reception station displays a message informing that the request for a change of the operation mode of the transmission station to the high-speed transmission mode has been made to the control/transmission station (corresponding to the step Receiver-202 of FIG. 31). Then, in the step (11)-03, the reception station transmits a signal for requesting change of operation mode of the transmission station to the control/transmission station (corresponding to the step Receiver-203 of FIG. 31).

Upon reception of the change request signal from the reception station in the step (11)-04, the control/transmission station displays in the step (11)-05 a message informing that the request for changing the operation mode into the high-speed transmission mode has been received from the reception station (corresponding to the step Sender-202 of FIG. 30). Then, in the steps (11)-06 and (11)-07, the control/transmission station sets the minimum transmission rate to 36 Mbps (corresponding to the step Sender-203 of FIG. 30).

Then, in the step (11)-08, the control/transmission station displays the new (updated) operation mode (high-speed transmission mode) (corresponding to the step Sender-204 of FIG. 30). Then, in the step (11)-09, the control/transmission station informs the reception station that the operation mode of the transmission station has been changed to the high-speed transmission mode (corresponding to the step Sender-205 of FIG. 30).

Upon reception of the notification, informing that the operation mode of transmission station has been changed to the high-speed transmission mode, from the control/transmission station in the step (11)-10 (corresponding to the step Receiver-204 of FIG. 31), the reception station displays in the step (11)-11 a message informing that the operation mode of the transmission station has been changed to the high-speed transmission mode (corresponding to the step Receiver-205 of FIG. 31), and then further displays in the step (11)-12 a message informing that the control/transmission station operates in the high-speed transmission mode (corresponding to the step Receiver-206 of FIG. 31).

Note that, the steps (11)-02, (11)-05, (11)-08 through (11)-12 are optional steps to provide displays enabling immediate recognition of the operation mode of the transmission station. Further, the foregoing example assumes the case of the high-speed transmission mode. In the case of the low-speed transmission mode, the minimum transmission rate is set to 12 Mbps, for example.

[Setting of High-Speed Transmission Mode (5)]

Here, with reference to FIGS. 30, 31 and 36, the following describes still another specific example of the structure in which the user sets the minimum transmission rate, that is the minimum value of the transmission PHY rate of the transmission station, to an appropriate value for the desired usage.

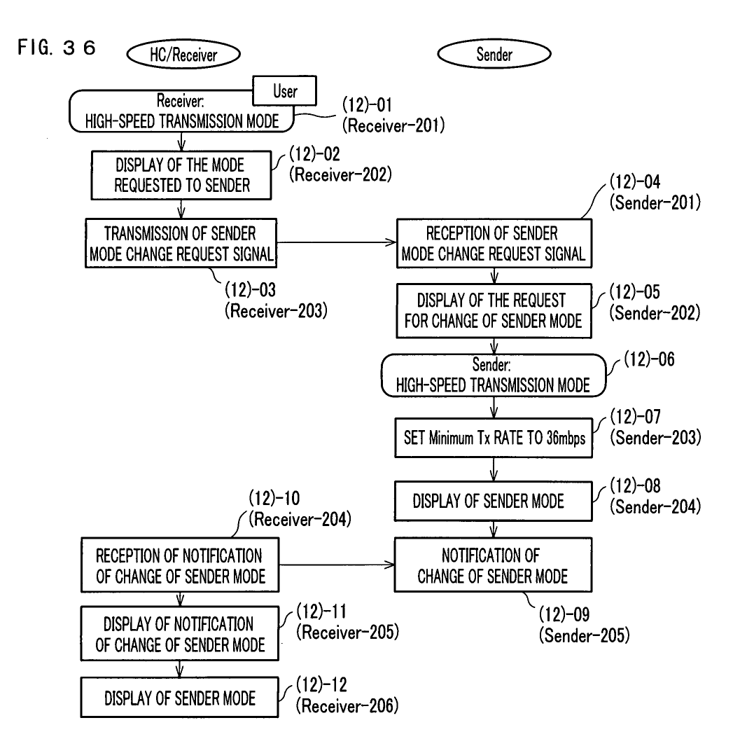

FIG. 36 shows an example where the user makes setting of the high-speed transmission mode for a transmission station (Sender) via a control/reception station (HC/Receiver), and transmits an operation mode change request signal to the transmission station. Note that, the control/reception station functions as both the control station and the reception station. For ease of explanation, it is assumed in this example that the minimum transmission rate corresponding to the high-speed transmission mode is 36 Mbps.

First, in the step (12)-01, the user makes a request for a change of the operation mode of the transmission station to the high-speed transmission mode to the high-speed transmission mode, via the control/reception station (corresponding to the step Receiver-201 of FIG. 31). The user performs this step by, for example, selecting the high-speed transmission mode through corresponding inputting means (e.g. push-button etc.). Upon the selection through the inputting means, in the step (12)-02, the control/reception station displays a message informing that the request for a change of the operation mode of the transmission station to the high-speed transmission mode has been made to the transmission station (corresponding to the step Receiver-202 of FIG. 31).

In response to this operation, in the step (12)-03, the control/reception station transmits a signal for requesting change of operation mode of the transmission station to the transmission station (corresponding to the step Receiver-203 of FIG. 31). Upon reception of the change request signal in the step (12)-04 (corresponding to the step Sender-201 of FIG. 30), the transmission station displays in the step (12)-05 a message informing that the request for changing the operation mode into the high-speed transmission mode has been received from the control/reception station (corresponding to the step Sender-202 of FIG. 30).

Then, in the steps (12)-06 and (12)-07, the transmission station sets the minimum transmission rate to 36 Mbps (corresponding to the step Sender-203 of FIG. 30). Further, in the step (12)-08, the transmission station displays the new (updated) operation mode (high-speed transmission mode) (corresponding to the step Sender-204 of FIG. 30). Then, in the step (12)-09, the transmission station informs the control/reception station that the operation mode of the transmission station has been changed to the high-speed transmission mode (corresponding to the step Sender-205 of FIG. 30).

Upon reception of the notification of the change to the high-speed transmission mode from the transmission station in the step (12)-10 (corresponding to the step Receiver-204 of FIG. 31), the control/reception station displays in the step (12)-11 a message informing that the operation mode of the transmission station has been changed to the high-speed transmission mode (corresponding to the step Receiver-205 of FIG. 31), and then further displays in the step (12)-12 a message informing that the transmission station operates in the high-speed transmission mode (corresponding to the step Receiver-206 of FIG. 31).

Note that, the steps (12)-02 and (12)-08 through (12)-12 are optional steps to provide displays enabling immediate recognition of the operation mode of the transmission station. Further, the foregoing example assumes the case of the high-speed transmission mode. In the case of the low-speed transmission mode, the minimum transmission rate is set to 12 Mbps, for example.

[Setting of High-Speed Transmission Mode (6)]

Here, with reference to FIGS. 30, 31, 34 and 37, the following describes yet another specific example of the structure in which the user sets the minimum transmission rate, that is the minimum value of the transmission PHY rate of the transmission station, to an appropriate value for the desired usage.

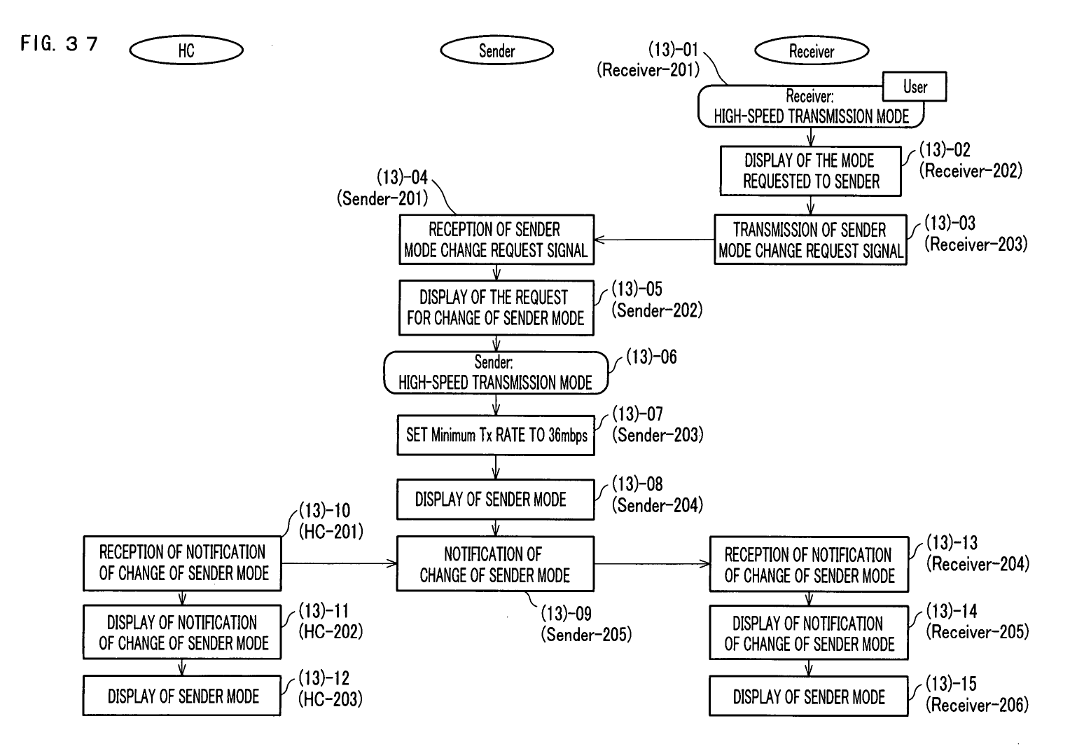

FIG. 37 shows an example where the user makes setting of the high-speed transmission mode for a transmission station (Sender) via a reception station (Receiver) (at the reception station), and transmits an operation mode change request signal to the transmission station. Note that, for ease of explanation, it is assumed in this example that the minimum transmission rate corresponding to the high-speed transmission mode is 36 Mbps.

First, in the step (13)-01, the user makes a request for a change of the operation mode of the transmission station to the high-speed transmission mode, via the reception station (at the reception station) (corresponding to the step Receiver-201 of FIG. 31). The user performs this step by, for example, selecting the high-speed transmission mode through corresponding inputting means (e.g. push-button etc.).

Upon the selection through the inputting means, in the step (13)-02, the reception station displays a message informing that the request for a change of the operation mode of the transmission station to the high-speed transmission mode has been made to the transmission station (corresponding to the step Receiver-202 of FIG. 31). In response to this operation, in the step (13)-03, the reception station transmits a signal for requesting change of operation of the transmission station to the transmission station (corresponding to the step Receiver-203 of FIG. 31).

Upon reception of the change request signal in the step (13)-04 (corresponding to the step Receiver-201 of FIG. 30), the transmission station displays in the step (13)-05 a message informing that the request for changing the operation mode into the high-speed transmission mode has been received from the reception station (corresponding to the step Sender-202 of FIG. 30). Then, in the steps (13)-06 and (13)-07, the transmission station sets the minimum transmission rate to 36 Mbps (corresponding to the step Sender-203 of FIG. 30).

Then, in the step (13)-08, the transmission station displays the new (updated) operation mode (high-speed transmission mode) (corresponding to the step Sender-204 of FIG. 30). Then, in the step (13)-09, the transmission station separately informs the control station and the reception station that the operation mode of the transmission station has been changed to the high-speed transmission mode (corresponding to the step Sender-205 of FIG. 30).

Upon reception of the notification of the change to the high-speed transmission mode from the transmission station in the step (13)-10 (corresponding to the step HC-201 of FIG. 34), the control station displays in the step (13)-11 a message informing that the operation mode of the transmission station has been changed to the high-speed transmission mode (corresponding to the step HC-202 of FIG. 34), and then further displays in the step (13)-12 a message informing that the transmission station operates in the high-speed transmission mode (corresponding to the step HC-203 of FIG. 34).

Meanwhile, upon reception of the notification of the change to the high-speed transmission mode from the transmission station in the step (13)-13 (corresponding to the step Receiver-204 of FIG. 31), the reception station displays in the step (13)-14 a message informing that the operation mode of the transmission station has been changed to the high-speed transmission mode (corresponding to the step Receiver-205 of FIG. 31), and then further displays in the step (13)-15 a message informing that the transmission station operates in the high-speed transmission mode (corresponding to the step Receiver-206 of FIG. 31).

Note that, the steps (13)-02, (13)-05, (13)-08 through (13)-15 are optional steps to provide displays enabling immediate recognition of the operation mode of the transmission station. Further, the foregoing example assumes the case of the high-speed transmission mode. In the case of the low-speed transmission mode, the minimum transmission rate is set to 12 Mbps, for example.

[Flow Chart for Setting of High-Speed Transmission Mode (1)]

FIGS. 34, 30 and 31 show flow charts of the described steps (8) through (13) of FIG. 28, in terms of the control station, the transmission station, and the reception station, respectively.

As shown in FIG. 34, when there is no reception of the signal for requesting a change of the operation mode of the transmission station in the step HC-201, the sequence goes to the step HC-204 to carry out judgment as to whether or not a request for addition of new stream or a request for a change of the existing stream has been made from the transmission station. When it is judged that the request for a change has been made, another judgment as to whether or not the request is acceptable is carried out (step HC-205), followed by either of the step HC-205 (to accept the request) or the step HC-207 (to reject the request).

As shown in FIG. 30, when there is no request for a change of the operation mode (high-speed transmission mode or low-speed transmission mode) of the transmission station, judgment is carried out as to whether or not a request for transmission of stream has been made (step Sender-206). When it is judged that the request for transmission of stream has been made, transmits a new stream addition request signal is transmitted to the control station (step Sender-207).

When the control station accepts the request for addition of new stream (step Sender-208), the transmission station carries out transmission of the stream with respect to the reception station, with a communication speed of at or greater than the minimum transmission rate that has been determined as a result of negotiation with the control station (step Sender-209). On the other hand, when the control station cannot accept the request for addition of new stream, judgment is carried out as to whether or not the minimum transmission rate can be increased (set the minimum transmission rate to a higher value) (step Sender-210). When it is judged that the increase is possible, the minimum transmission rate is increased (step Sender-211), and then the sequence goes to the step Sender-208 to repeat the process.

As explained, the minimum transmission rate, that is the minimum value of the transmission PHY rate of the transmission station, can be set at the transmission station or the reception station anytime according to the desired usage of the user, through input means, such as a push-button, by the user or making a request for a change of the operation mode.

For example, if the user wants to carry out transmission with a rate of not less than 36 Mbps in the first place, he/she sets the minimum transmission rate of the transmission station to 36 Mbps, for the transmission station or the reception station (otherwise, the user selects the high-speed transmission mode through a corresponding push-button). Similarly, if the user wants to carry out transmission with a rate not less than 12 Mbps, he/she sets the minimum transmission rate of the transmission station to 12 Mbps, for the transmission station or the reception station. In this way, the user can make setting of the minimum transmission rate for the transmission station anytime with an arbitrary value according to the desired usage.

[Epitome of Processes for Changing Operation Mode]

The following epitomizes the described processes for changing the operation mode (station number priority mode, distance priority mode) of the control station, and the processes for changing the operation mode (high-speed transmission mode, low-speed transmission mode) of the transmission station.

In setting of either of the station number priority mode and the distance priority mode for the control station, (1) the control station operating in the station number priority mode reject a transmission station with a communication speed (minimum transmission rate) lower than the predetermined threshold value (set to 36 Mbps in the foregoing example); (2) the control station guarantees provision of TXOP enabling communication with the threshold (36 Mbps) after it accepts a transmission station, even when the transmission station carries out transmission with a threshold value equal to or greater than the threshold value (e.g. 48 Mbps or 54 Mbps); (3) the control station operating in the distance priority mode reject a transmission station with a communication speed (minimum transmission rate) lower than the predetermined threshold value (set to 12 Mbps in the foregoing example); and (4) the control station guarantees provision of TXOP enabling communication with the threshold (12 Mbps) after it accepts a transmission station, even when the transmission station carries out transmission with a threshold value equal to or greater than the threshold value (e.g. 48 Mbps or 54 Mbps) (In the conventional method, the control station automatically increase the communication speed to, for example 24 Mbps, even after it accepts a communication station, so that the TXOP allow only communication at or greater than 24 Mbps).

Further, in setting of either of the station number priority mode and the distance priority mode for the control station, (1) the transmission station operating in the high-speed transmission mode carries out communication at or greater than the minimum transmission rate (set to 36 Mbps in the foregoing example) (when the request for transmission with 36 Mbps is rejected, the transmission station again makes request to the control station with a rate of 48 Mbps or 54 Mbps), and the transmission station operating in the low-speed transmission mode carries out communication at or greater than the minimum transmission rate (set to 12 Mbps in the foregoing example) (when the request for transmission with 12 Mbps is rejected, the transmission station again makes request to the control station with a rate of 24 Mbps, 36 Mbps, 48 Mbps or 54 Mbps).

The present invention is not limited to the two types of operation mode (the station number priority mode and the distance priority mode, the high-speed transmission mode and the low-speed transmission mode) but may include respective combinations of those.

[Structure of Control Station]

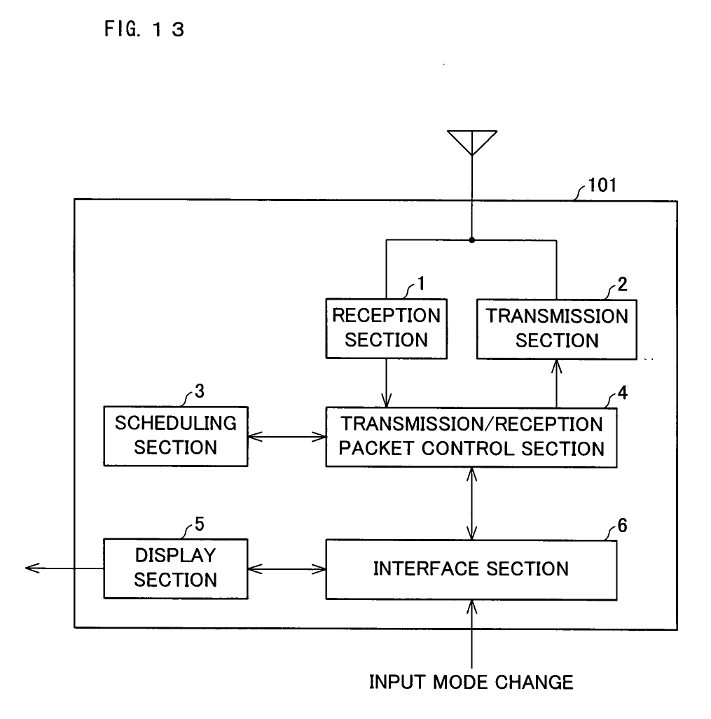

Here, with reference to FIG. 13, the following briefly describes the control station used in the present embodiment above.

The control station is mainly made up of a reception section 1, transmission section 2, scheduling section 3, a transmission/reception packet control section 4, a display section 5, and an interface section 6.

The reception section 1 serves to perform reception of Tsec and Qos Null. The transmission section 2 serves to perform transmission of CF-Poll. The transmission/reception packet control section 4 manages transmission timing of CF-Poll and requests necessary data to the scheduling section 3, and also extracts necessary data from the Tsec/Qos Null, and transmits the extracted data to the scheduling section 3.

The interface section 6 serves to transmit mode change instruction, which has been inputted by the user, to the transmission/reception packet control section 4. Further, the display section 5 serves to carry out display of the current mode setting (one of the distance priority mode and the station number priority mode), a request for mode change of the control station, that are notified by the control station, the setting of the transmission station currently accepted by the control station, and/or notification of the change of the setting (one of the high-speed transmission mode and the low-speed transmission mode) of the transmission station.

The scheduling section (scheduler) 3 serves to (1) decide acceptance of a stream from TSpec, to (2) update setting of TXOP according to QoS Null, and to (3) receive the request for transmission of CF-Poll so as to transmit the necessary data to the transmission/reception packet control section 4.

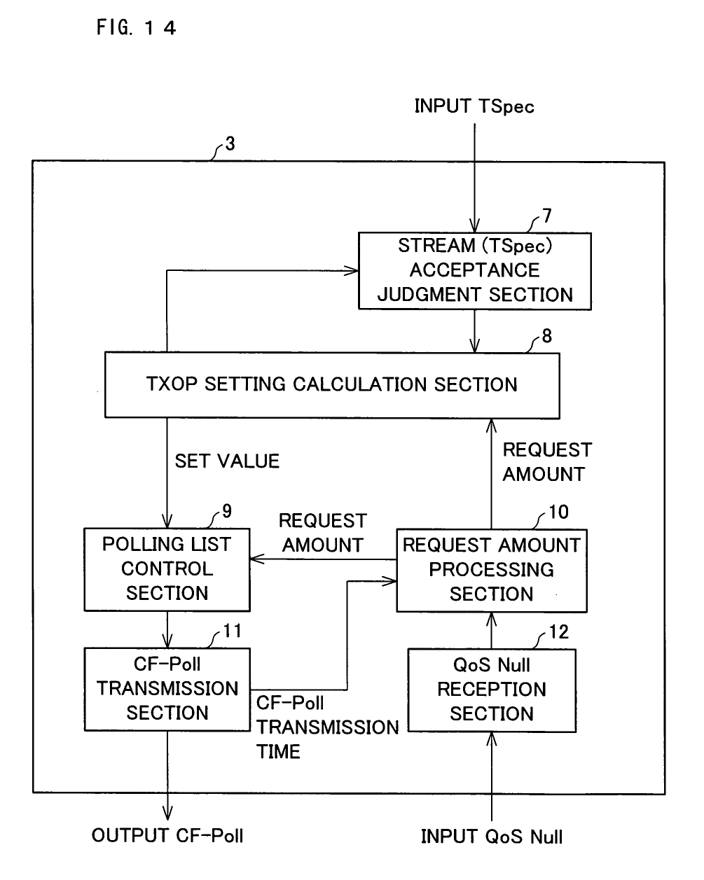

As shown in FIG. 14, the scheduling section 3 is mainly made up of a stream acceptance judgment section 7, a TXOP setting calculation section 8, a polling list control section 9, a request amount processing section 10, a CF-Poll transmission section 11, and a QoS Null reception section 12.

The stream acceptance judgment section 7 serves to decide acceptance of a stream according to the current condition of the communication band. The TXOP setting calculation section 8 carries out calculation of TXOP based on TSpec/Qos Null to create a polling list to make setting of TXOP.

The polling list control section 9 serves to inform the CF-Poll transmission section 11 of information of the TXOP set by the TXOP setting calculation section 8, and that which of the transmission stations obtains the remaining period of the polling interval.

The request amount processing section 10 serves to calculate actual consumed time of TXOP according to the time where the CF-Poll was thrown and the time where Qos Null is received. In addition to this, the request amount processing section 10 simultaneously processes QoS Null so as to report the content thereof separately to the TXOP setting calculation section 8 and the polling list control section 9.

The CF-Poll transmission section 11 serves to transmit CF-Poll, and the QoS Null reception section 12 serves to receive QoS Null.

[Structure of Transmission Station]

Next, with reference to FIG. 15, the following briefly describes the transmission station (terminal transmission station) used in the present embodiment above.

The control station is mainly made up of a reception section 13, transmission section 14, a transmission/reception packet control section 15, a display section 16, and an interface section 17.

The reception section 13 serves to perform reception of CF-Poll. The transmission section 14 serves to perform transmission of stream data and QoS Null. The transmission/reception packet control section 16 receives CF-Poll and manages TXOP time, and also selects the stream data or Qos Null according to the remaining time of TXOP, and transmits the selected data.

The interface section 17 serves to transmit inputted mode change instruction to the transmission/reception packet control section 15. Further, the display section 16 serves to carry out display of the mode setting (one of the distance priority mode and the station number priority mode) of the control station, that is notified by the control station, the mode (one of the distance priority mode and the station number priority mode) of the control station requested to the control station by the transmission station and/or the reception station, notification of mode change of the control station, notification and/or reason for rejection of the mode change of the control station, setting (one of the high-speed transmission mode and the low-speed transmission mode) of the transmission station, and/or a request for mode change of the transmission station, that is notified by the control station.

[Structure of Reception Station]

Next, with reference to FIG. 16, the following briefly describes the reception station (terminal reception station) used in the present embodiment above.

The control station is mainly made up of a reception section 18, transmission section 19, a transmission/reception packet control section 20, a display section 21, and an interface section 22.

The reception section 18 serves to perform reception of stream data. The transmission section 19 serves to perform transmission of AcK. The transmission/reception packet control section 20 receives the stream data, and send back the Ack if required.

The interface section 22 serves to externally output the stream data. Further, the display section 21 serves to carry out display of the mode setting (one of the distance priority mode and the station number priority mode) of the control station, that is notified by the control station, the mode (one of the distance priority mode and the station number priority mode) requested to the control station by the reception station, notification of mode change of the control station, notification and/or reason for rejection of the mode change of the control station, setting (one of the high-speed transmission mode and the low-speed transmission mode) of the transmission station, the mode (one of the high-speed transmission mode and the low-speed transmission mode) requested to the transmission station by the reception station, and/or notification of mode change of the transmission station, that is notified by the control station.

As explained, in order to solve the foregoing problems, the scheduling method of the present invention, that is used for a communication management system to manage the band, is arranged so that, when transmission/reception of data via, for example, a wireless medium, is performed between a plurality of communication stations, only a transmission station currently having a transmission right is allowed to carry out data transmission. In this arrangement, the transmission station informs the control station of its buffering condition or of information of desired length of the transmission right so that the control station provides the transmission station with the length adjusted according to the information, the provision of transmission right given to each transmission station performed by the control station is carried out at periodic intervals.

When a plurality of communication stations exist, only a transmission station currently having a transmission right is allowed to carry out data transmission, and the control station provides the transmission station with the length adjusted according to the information supplied from the transmission station. In this case, if the provision of transmission right to the transmission stations performed by the control station is carried out at nonperiodic intervals, as with a generally-adopted method, the control station will have to handle limitless amount of data to manage the order of provision and the length of the transmission right for the number of transmission stations.

In this view, the foregoing scheduling method is arranged so that the control station controls provision of a transmission right so that the provision is carried out to each of the respective transmission stations at periodic intervals. In this manner, the control station is allowed to control time information of the transmission right to be given at periodic intervals, and therefore the control station will have to manage the order of provision and the length of the transmission right for the number of transmission stations within the periodic interval, thereby securely reducing the information amount to be managed.

Further, when adjusting transmission right grant time according to the information notified by the transmission station, the foregoing method adjusts the time at periodic intervals, and therefore some necessary actions may be taken for the transmission station in a bad communication condition at least in the next period.

In the foregoing scheduling method, it is preferable that the control station re-allots a transmission right to a transmission station when there is a blank period in the backmost of the periodic interval.

In this case, the provision of transmission right to transmission stations is performed at periodic intervals, and when there is a blank period in the backmost of the duration of the periodic interval, the transmission right is re-allotted to a transmission station. In this manner, it is possible to securely prevent waste of the communication band, thereby realizing effective use of the communication band.

In the foregoing scheduling method, when the transmission right is re-allotted to the transmission station, the reallocation is preferably performed in accordance with one of: (i) buffer conditions or requested lengths of the transmission rights, reported from said communication stations, (ii) actual lengths that have been allotted to said communication stations, (iii) a priority previously decided for each communication station, or (iv) a combination of at least two of (i) through (iii).

In this case, it is possible to securely prevent waste of the communication band, thereby securely realizing effective use of the communication band. Further, the transmission right is re-allotted to the transmission station in a bad communication condition and/or precedent in priority, thereby realizing immediate error correction for the transmission station to which the transmission right is given.

In the foregoing scheduling method, when there is a blank period in the periodic interval, it is preferable that the control station provides transmission right by adding the blank time to the adjusted transmission right grant periods.

In this case, when there is a blank period in the periodic interval, the control station provides transmission rights by adding the blank time to the adjusted transmission right grant periods. With this arrangement, the data transmission may be carried out with plenty of communication band.

In the foregoing scheduling method in which the blank period is used as a part of the transmission right grant period, the transmission right grant period including the blank period may be decided in consideration of one of: (i) buffer conditions or requested lengths of the transmission rights, reported from said communication stations, (ii) actual lengths that have been allotted to said communication stations, (iii) a priority previously decided for each communication station, or (iv) a combination of at least two of (i) through (iii).

In this manner, data transmission is carried out with plenty of communication band, and a longer transmission right grant period is allotted to the transmission station in a bad communication condition and/or precedent in priority, thereby realizing immediate error correction for the transmission station to which the transmission right is given.

In order to solve the foregoing conventional problems, another scheduling method of the present invention, that is used as a scheduling method to manage the band of a communication management system, is arranged so that, when transmission/reception of data via, for example, a wireless medium, is performed between a plurality of communication stations, only a transmission station currently having a transmission right is allowed to carry out data transmission, and the transmission station informs the control station of its buffering condition or of information of desired length of the transmission right so that the control station provides the transmission station with the length adjusted according to the information. This method is further arranged to carry out control to protect a transmission station in a good communication condition from a transmission station whose transmission is regarded in a bad condition in consideration of its buffering condition or of information of desired length of the transmission right.

In the case of carrying out data transmission/reception with a plurality of transmission stations using a wireless medium or the like, if the scheduling is performed by directly reflecting the buffering conditions or of information of desired lengths of the transmission right, a transmission station in a bad condition affects other transmission stations in a tolerable condition.

In this view, the foregoing method is arranged to carry out a control in scheduling to protect transmission stations from influence of a transmission station in a bad communication condition. Accordingly, the transmission station in a tolerable communication condition can be immune to bad influence from the transmission station in a bad condition, thereby securely carrying on the transmission. This arrangement offers superior reliability of the system.

In the foregoing scheduling method, it is preferable that the control station sets an upper limit of the transmission right grant period, and when the result of adjustment of the given time exceeds the upper limit, the control station carries out a control to keep the transmission right grant time given to the transmission right at or lower than the upper limit.

In this manner, an upper limit is set for the times to be given to the respective transmission stations. Then, when the transmission right grant period is adjusted based on the buffering conditions or the information of desired lengths of transmission right of the transmission station in a bad condition, and the resulting adjustment value is greater than the upper limit, the control station carries out a control to keep the given time at or lower than the upper limit. Accordingly, the transmission station in a normal communication condition may be securely protected from influence of the transmission station in a bad communication condition.

In the foregoing scheduling method, it is preferable that the control station sets a lower limit of the transmission right grant period, and when the result of adjustment of the given time falls below the lower limit, the control station carries out a control to keep the transmission right grant time given to the transmission right at or greater than the lower limit.

In this manner, a lower limit is set for the transmission right grant period given to the respective transmission stations. When the system includes a transmission station performing data transmission of various data rate, the resulting value may greatly vary when the adjustment of the transmission right grant period is carried out according to the buffering condition or of information of desired length of the transmission right. In this view, the foregoing method carries out a control to keep the transmission right grant time given to the transmission right at or greater than the lower limit if the resulting value falls below the lower limit. On this account, the minimum length is guaranteed for the transmission right grant period, thus allowing the system to carry out stable data transmission. This contributes significant improvement in reliability.

The foregoing scheduling method may be arranged so that, when the total length of the transmission right grant period given to the respective transmission stations at the periodic intervals exceeds the duration of the period, the schedule is controlled by preferentially reducing the length to be given to the transmission station that has requested a value most greatly differ from the reference value, so that the total given time falls within the foregoing interval.

When the system includes a transmission station in a bad communication condition, the resulting value of the given time for the respective transmission station may fall outside the period. In this case, if the transmission right is continuously provided to the transmission station in a bad communication station, it causes some bad influence on other transmission stations in a normal communication condition.

In this view, the foregoing scheduling method carries out calculation to find the difference between the resulting adjustment value of given time for each transmission station and a corresponding reference value, and then preferentially reduces the time given to the transmission station requested a value with a larger difference from the reference value. This arrangement disables the transmission station having the great difference to carry out desirable transmission, however prevents some bad influence exerted on the other transmission stations, thus allowing them to carry on the transmission.

Still another scheduling method of the present invention, that is used as a scheduling method to manage the band of a communication management system, is arranged so that, when transmission/reception of data via, for example, a wireless medium, is performed between a plurality of communication stations, only a transmission station currently having a transmission right is allowed to carry out data transmission, and the transmission station informs the control station of its buffering condition or of information of desired length of the transmission right so that the control station provides the transmission station with the length adjusted according to the information. This method is further arranged so that the operation mode of the control station can be switched between a distance priority mode and a station number priority mode.

Generally, increasing the transmission distance and supporting a large number of transmission stations (stream) conflict with each other. In this view, upon provision of the transmission rights to the transmission stations, the described prior art has no guideline to refer to the user's intention to decide whether the priority should be given to the distance or should be given to the support for a plurality of transmission stations (stream).

In view of this problem, the foregoing scheduling method is arranged to enable selection between a distance priority mode and a station number priority mode. On this account, the user can carry out desirable mode setting.

Note that, the present invention is not limited to the embodiments above, but may be altered within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The communication management method of the present invention is suitably used for, for example, a network system in which home-use electric products having wireless communication function are connected to each other as a domestic LAN. More specifically, the present invention may be used for a system comprising an image data output device, such as a DVD player or a cable TV modem, and a display device for displaying video images based on the image data, that are connected via a network.

1. A communication management method for a communication system that is made up of a plurality of communication stations and a control station for controlling transmission rights of said communication stations,
said method being performed by the control station and comprising the step of:
allotting a transmission right grant period to at least one of said communication stations within a predefined period according to a request for transmission right from said at least one of the communication stations, said predefined period being specified in length.

2. The communication management method as set forth in claim 1, wherein:
said predefined period is continuously set while having a certain periodicity.

3. A communication management method for a communication system that is made up of a plurality of communication stations and a control station for controlling transmission rights of said communication stations,
said method being performed by the control station and comprising the steps of:
(a) allotting a transmission right grant period to at least one of said communication stations within a predefined period according to a request for transmission right from said at least one of said communication stations; and
(b) re-allotting a transmission right to at least one of said communication stations within said predefined period at a time point where all communication stations, that have been provided with transmission rights, consume their transmission right grant periods, or complete their transmission within said transmission right grant periods.

4. The communication management method as set forth in claim 3 or claim 47, wherein:
the step (b) is performed by re-allotting a transmission right to at least one of said communication stations within said predefined period in accordance with one of: (i) buffer conditions or requested lengths of the transmission rights, reported from said communication stations, (ii) actual lengths that have been allotted to said communication stations, (iii) a priority previously decided for each communication station, or (iv) a combination of at least two of (i) through (iii).

5. A communication management method for a communication system that is made up of a plurality of communication stations and a control station for controlling transmission rights of said communication stations,
said method being performed by the control station and comprising the step of:
(a) allotting a transmission right grant period to at least one of said communication stations within a predefined period according to a request for transmission right from said at least one of the communication stations,
said transmission right grant period allotted within said predefined period being decided according to previous communication conditions and/or characteristics of said communication stations, said transmission right grant period being decided for each of the predefined period, or, when said predefined period is continuously set while having a certain periodicity, said transmission right grant period being decided for each period of the periodicity.

6. The communication management method as set forth in claim 5 or claim 48, wherein:
the step (a) is performed by allotting a transmission right grant period in accordance with one of: (i) buffer conditions or requested lengths of the transmission rights, reported from said communication stations, (ii) actual length that have been allotted to said communication stations, (iii) a priority previously decided for each communication station, or (iv) a combination of at least two of (i) through (iii).

7. A communication management method for a communication system that is made up of a plurality of communication stations and a control station for controlling transmission rights of said communication stations,
said method being performed by the control station and comprising the step of:
allotting a transmission right grant period to at least one of said communication stations within a predefined period according to a request for transmission right from said at least one of the communication stations, said transmission right grant period having an upper limit and/or a lower limit.

8. The communication management method as set forth in claim 6, wherein:
a reference value of the transmission right grant period is set for each of said communication stations, and when decided transmission right grant periods to be allotted falls outside the predefined period, a transmission right grant period for a communication station requiring a transmission right grant period with a larger difference than a corresponding reference value is preferentially reduced, so that said transmission rights can be provided within the predefined period.

9. A communication management method for a communication system that is made up of a plurality of communication stations and a control station for controlling transmission rights of said communication stations,
said method being performed by the control station and comprising the step of:
allotting a transmission right grant period to at least one of said communication stations within a predefined period according to a request for transmission right from said at least one of the communication stations, an operation mode being switched between a distance priority mode and a station number priority mode.

10. The communication management method as set forth in claim 9, further comprising the step of:
setting a threshold value to be used for judgment as to whether a minimum transmission rate, that is a minimum value of a transmission rate notified by a transmission station, is acceptable or not.

11. The communication management method as set forth in claim 10, wherein:
said threshold value is differently decided for the distance priority mode and for the station number priority mode.

12. The communication management method as set forth in claim 9, further comprising the step of:
receiving a request for mode change from a transmission station or a reception station.

13. The communication management method as set forth in claim 9, further comprising the step of:
when the operation mode is changed, notifying a transmission station or a reception station of the mode change.

14. The communication management method as set forth in claim 9, further comprising the step of:
when the operation mode is not changed, displaying in display means provided in said control station a notification that the operation mode is not changed.

15. The communication management method as set forth in claim 9, further comprising the step of:
when the operation mode is not changed, displaying in display means provided in said control station a reason why the operation mode is not changed.

16. The communication management method as set forth in claim 9, further comprising the step of:
when the operation mode is not changed, notifying a transmission station and/or a reception station that the operation mode is not changed.

17. The communication management method as set forth in claim 9, further comprising the step of:
when the operation mode is not changed, notifying a transmission station and/or a reception station of a reason why the operation mode is not changed.

18. The communication management method as set forth in claim 12, further comprising the step of:
displaying in display means provided in said control station a current operation mode and an operation mode requested by said transmission or said reception station.

19. A control station provided in a communication system that is made up of a plurality of communication stations and a control station for controlling transmission rights of said communication stations,
said control station comprising:
a reception section for receiving requests for transmission right from said plurality of communication stations;
a transmission section for transmitting information to provide transmission rights with respect to at least a part of said communication stations; and
a scheduling section for carrying out said communication management method as set forth in claim 1.

20. A control station provided in a communication system that is made up of a plurality of communication stations and said control station for controlling transmission rights of said communication stations,
said control station comprising:
a reception section for receiving requests for transmission right from said plurality of communication stations;
a transmission section for transmitting information to provide transmission rights with respect to at least a part of said communication stations; and
a scheduling section for carrying out said communication management method as set forth in claim 9.

21. A communication management method for a communication system that is made up of a plurality of communication stations and said control station as set forth in claim 20 for controlling transmission rights of said communication stations,
said method being performed by the communication station and comprising the step of:
displaying in display means provided in said communication station whether said control station is operated under the distance priority mode or the station number priority mode.

22. A communication management method for a communication system that is made up of a plurality of communication stations and said control station as set forth in claim 19 for controlling transmission rights of said communication stations,
said method being performed by the communication station and comprising the step of:
when there is a transmission station that cannot be connected to a communication network of the communication system, displaying in display means provided in said communication station a reason why the transmission station cannot be connected to the communication network.

23. A communication management method for a communication system that is made up of a plurality of communication stations and said control station as set forth in claim 20 for controlling transmission rights of said communication stations,
said method being performed by the communication station and comprising the step of:
when said communication station carries out transmission, requesting to said control station change of the operation mode to the distance priority mode or to the station number priority mode.

24. The communication management method as set forth in claim 23, further comprising the step of:
when said communication station carries out transmission, displaying in display means provided in said control station a current operation mode of said control station, and an operation mode that has been requested to said control station.

25. The communication management method as set forth in claim 23, further comprising the step of:
upon reception of a notification from said control station informing that the operation mode is changed, displaying the notification in display means provided in said communication station.

26. The communication management method as set forth in claim 23, further comprising the step of:
upon reception of a notification from said control station informing that a request for mode change is rejected, displaying the notification in display means provided in a communication station that had transmitted the request.

27. The communication management method as set forth in claim 23, further comprising the step of:
upon reception of a notification from said control station informing that a request for mode change is rejected, displaying a reason why the request is rejected in display means provided in a communication station that had transmitted the request.

28. A communication management method for a communication system that is made up of a plurality of communication stations and said control station as set forth in claim 20 for controlling transmission rights of said communication stations, said method being performed by the communication station and comprising the step of:
upon reception of data from a transmission station, requesting to said control station via said transmission station change of the operation mode to the distance priority mode or to the station number priority mode.

29. The communication management method as set forth in claim 28, further comprising the step of:
when said communication station carries out reception, displaying in display means provided in said control station a current operation mode of said control station, and an operation mode that has been requested to said control station.

30. The communication management method as set forth in claim 28, further comprising the step of:
upon reception of a notification from said control station via said transmission station informing that the operation mode is changed, displaying the notification in display means provided in said communication station.

31. The communication management method as set forth in claim 28, further comprising the step of:
upon reception of a notification from said control station informing that a request for mode change is rejected, displaying the notification in display means provided in a communication station that had transmitted the request.

32. The communication management method as set forth in claim 26, further comprising the step of:
upon reception of a notification from said control station informing that a request for mode change is rejected, displaying a reason why the request is rejected in display means provided in a communication station that had transmitted the request.

33. A communication management method for a communication system that is made up of a plurality of communication stations and either of said control station as set forth in claim 20 or said control station for carrying out said communication management method as set forth in claim 8 for controlling transmission rights of said communication stations, said method being performed by the communication station,
wherein:
an operation mode for transmission can be switched between a high-speed transmission mode and a low-speed transmission mode.

34. The communication management method as set forth in claim 33, wherein:
a minimum transmission rate, that is a minimum value of a transmission rate, is set.

35. The communication management method as set forth in claim 34, wherein:
said minimum transmission rate is differently decided for the high-speed transmission mode and for the low-speed transmission mode.

36. The communication management method as set forth in claim 33, comprising the step of:
when the operation mode is changed, notifying said reception station on a receiving end and said control station of the mode change.

37. The communication management method as set forth in claim 33, further comprising the step of:
displaying in display means provided in said communication station a current operation mode.

38. The communication management method as set forth in claim 33, comprising the step of:
upon reception of a notification from said control station informing that the operation mode is changed, displaying the notification in display means provided in said communication station.

39. A communication management method performed by a communication station operating as a reception station for carrying out reception from a communication station operating as a transmission station for carrying out the communication management method as set forth in claim 33, said method comprising the step of:
displaying in display means provided in said communication station as a reception station a current operation mode of said transmission station.

40. The communication management method as set forth in claim 39, further comprising the step of:
upon reception of a notification from said control station informing that the operation mode is changed, displaying the notification in display means provided in said communication station as a reception station.

41. The communication management method as set forth in claim 39, further comprising the step of:
requesting change of the operation mode of said transmission station to the high-speed transmission mode or to the low-speed transmission mode.

42. A communication station provided in a communication system that is made up of a plurality of communication stations and a control station for controlling transmission rights of said communication stations,
said communication station comprising:
a transmission and/or a reception section for transmitting and/or receiving information to/from said communication stations and said control station; and
a scheduling section for carrying out said communication management method as set forth in claim 21.

43. A communication management method performed by a control station for controlling a transmission right of a communication station operating as a transmission station for carrying out the communication management method as set forth in claim 33, said method comprising the step of:
displaying in display means provided in said control station a current operation mode of said transmission station.

44. A control station provided in a communication system that is made up of a plurality of communication stations and said control station for controlling transmission rights of said communication stations,
said control station comprising:
a reception section for receiving requests for transmission right from said plurality of communication stations;
a transmission section for providing transmission rights to at least a part of said communication stations; and
a scheduling section for carrying out said communication management method as set forth in claim 43.

45. A communication management program for causing a computer to carry out the communication management method as set forth in claim 1.

46. A storage medium storing the communication management program as set forth in claim 45.

47. A communication management method for a communication system that is made up of a plurality of communication stations and a control station for controlling transmission rights of said communication stations,
said method being performed by the control station and comprising the steps of:
(a) allotting a transmission right grant period to at least one of said communication stations within a predefined period according to a request for transmission right from said at least one of communication stations; and
(b) re-allotting a transmission right to at least one of communication stations having been reported communication condition within said predefined period, said transmission right being re-allotted within said predefined period at a time point where all communication stations, that have been provided with transmission rights, consume their transmission right grant periods, or complete their transmission within said transmission right grants.

48. A communication management method for a communication system that is made up of a plurality of communication stations and a control station for controlling transmission rights of said communication stations,
said method being performed by the control station and comprising the step of:
(a) allotting a transmission right grant period to at least one of said communication stations within a predefined period according to a request for transmission right from said at least one of the communication stations,
said transmission right grant period allotted within said predefined period being re-arranged for communication stations having been reported communication condition within said predefined period, said transmission right grant period being re-arranged according to previous communication conditions and/or characteristics of said communication stations, said transmission right grant period being decided for each of the predefined period, or, when said predefined period is continuously set while having a certain periodicity, said transmission right grant period being decided for each period of the periodicity.
(b) re-allotting a transmission right to at least one of communication stations having been reported communication condition within said predefined period, said transmission right being re-allotted within said predefined period at a time point where all communication stations, that have been provided with transmission rights, consume their transmission right grant periods, or complete their transmission within said transmission right grants.
